(19) United States
(12) Patent Application Publication
(10) Pub. No.: US 2026/0133520 A1
(43) Pub. Date: May 14, 2026

(54) IMAGE FORMING APPARATUS

(71) Applicant: FUJIFILM Business Innovation Corp., Tokyo (JP)

(72) Inventors: Fuyuki KANO, Kanagawa (JP); Yoichi KIGOSHI, Kanagawa (JP); Yuki OYAMADA, Kanagawa (JP); Kohei TAKAOKA, Kanagawa (JP); Keisuke KUSANO, Kanagawa (JP); Tomoya SASAKI, Kanagawa (JP); Kenta IDE, Kanagawa (JP)

(73) Assignee: FUJIFILM Business Innovation Corp., Tokyo (JP)

(21) Appl. No.: 19/199,373

(22) Filed: May 5, 2025

(30) Foreign Application Priority Data
Nov. 11, 2024 (JP) 2024-197016

(51) Int. Cl. G03G 15/02; G03G 5/047; G03G 5/07

(52) U.S. Cl. CPC G03G 15/0225; G03G 5/047; G03G 5/076; G03G 15/0233; G03G 2215/025

(57) ABSTRACT

An image forming apparatus includes an electrophotographic photoreceptor, and a charging device including a charging member that charges a surface of the electrophotographic photoreceptor and a cleaning member that is disposed in contact with the charging member, in which the electrophotographic photoreceptor has a conductive substrate and a photosensitive layer disposed on the conductive substrate, and an outermost surface layer of the electrophotographic photoreceptor contains a charge transport material and a polyarylate resin having a dicarboxylic acid unit represented by Formula (A) and a diol unit represented by Formula (B), the cleaning member has a core metal and a foamed elastic layer provided in a helical shape on an outer peripheral surface of the core metal, and a value of a ratio T/W of a thickness T of the foamed elastic layer to a width W of the foamed elastic layer is 0.6 or more and 1.2 or less,

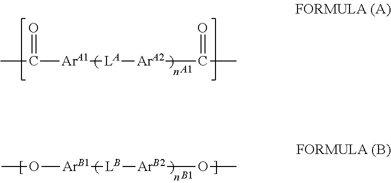

in Formula (A), Ar^{A1} and Ar^{A2} are each independently an aromatic ring which may have a substituent, L^{A} is a single bond or a divalent linking group, and n^{A1} is 0, 1, or 2,
in Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

### CROSS-REFERENCE TO RELATED APPLICATIONS

This application is based on and claims priority under 35 USC 119 from Japanese Patent Application No. 2024-197016 filed Nov. 11, 2024.

### BACKGROUND

### (i) Technical Field

The present invention relates to an image forming apparatus.

### (ii) Related Art

JP2005-309039A discloses an image forming apparatus in which a latent image carrier is charged using a charging member that comes into contact with the latent image carrier and is rotationally driven, the charged latent image carrier is exposed to form an electrostatic latent image, the electrostatic latent image is developed using toner carried by a toner carrying body to form a toner image, the toner image formed on the latent image carrier is transferred onto a transfer material using a transfer member that abuts onto the latent image carrier and is rotated, a transfer residual toner remaining on the latent image carrier after the transfer is collected by a cleaning unit, the toner image on the transfer material after the transfer is fixed to the transfer material by a fixing unit, the charging member has a material having high release properties on a surface, and the transfer member is formed of a foaming body and has a skin layer on a surface.

JP2012-78518A discloses a charging device including a charging member, and a cleaning member having a core body and an elastic layer that contains silicone oil and is disposed in a helical shape on an outer peripheral surface of the core body, in which after the elastic layer of the cleaning member in an initial state and the charging member in the initial state are brought into contact with each other for 24 hours, among contents of Si atoms constituting a siloxane skeleton with respect to all atoms, which are obtained by analyzing a surface of the charging member by X-ray photoelectron spectroscopy, a maximum value of a content of Si atoms constituting the siloxane skeleton in a contact portion, which is a region in contact with the elastic layer, and a content of Si atoms constituting the siloxane skeleton in a non-contact portion, which is a region not in contact with the elastic layer, is 6 atom % or less.

JP2014-146001A discloses a positively charged lamination-type electrophotographic photoreceptor in which a lamination-type photosensitive layer where a charge transport layer consisting of at least a hole transport material and a binder resin and a charge generation/transport layer consisting of at least a charge generation material, an electron transport material, a hole transport material, and a binder resin are sequentially laminated on a conductive substrate is formed, the binder resin in the charge transport layer contains a polyarylate resin, a thickness of the charge transport layer is 10 to 40 m, and a thickness of the charge generation/transport layer is 3 to 20 km.

### SUMMARY

Aspects of non-limiting embodiments of the present disclosure relate to an image forming apparatus in which an outermost surface layer of an electrophotographic photoreceptor does not contain a charge transport material and a polyarylate resin having a dicarboxylic acid unit represented by Formula (A) and a diol unit represented by Formula (B), or a cleaning member has a core metal and a foamed elastic layer provided in a helical shape on an outer peripheral surface of the core metal, and in which abrasion-suppressing properties of a photoreceptor and contamination-suppressing properties of a charging member are excellent as compared with a case where a value of a ratio T/W of a thickness T of the foamed elastic layer to a width W of the foamed elastic layer is less than 0.6 or more than 1.2.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an image forming apparatus including an electrophotographic photoreceptor, and a charging device including a charging member that charges a surface of the electrophotographic photoreceptor and a cleaning member that is disposed in contact with the charging member, in which the electrophotographic photoreceptor has a conductive substrate and a photosensitive layer disposed on the conductive substrate, and an outermost surface layer of the electrophotographic photoreceptor contains a charge transport material and a polyarylate resin having a dicarboxylic acid unit represented by Formula (A) and a diol unit represented by Formula (B), the cleaning member has a core metal and a foamed elastic layer provided in a helical shape on an outer peripheral surface of the core metal, and a value of a ratio T/W of a thickness T of the foamed elastic layer to a width W of the foamed elastic layer is 0.6 or more and 1.2 or less.

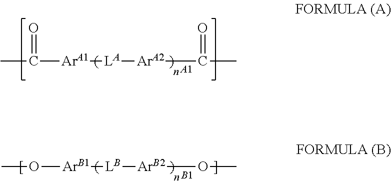

In Formula (A), Ar^{A1} and Ar^{A2} are each independently an aromatic ring which may have a substituent, L^{A} is a single bond or a divalent linking group, and n^{A1} is 0, 1, or 2.

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2. Where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

### BRIEF DESCRIPTION OF THE DRAWINGS

Exemplary embodiment(s) of the present invention will be described in detail based on the following figures, wherein:

FIG. 1 is an enlarged cross-sectional view showing a foamed elastic layer in an example of a cleaning member used in the present exemplary embodiment;

FIG. 2 is a side view showing a schematic configuration of an example of a charging device used in the present exemplary embodiment;

FIG. 3 is a front view showing a schematic configuration of an example of the charging device used in the present exemplary embodiment;

FIG. 4 is a schematic side view showing an example of a cleaning member used for the charging device used in the present exemplary embodiment;

FIG. 5 is a partial cross-sectional view showing an example of a layer configuration of an electrophotographic photoreceptor;

FIG. 6 is a partial cross-sectional view showing an example of the layer configuration of the electrophotographic photoreceptor;

FIG. 7 is a schematic configuration view showing an example of an image forming apparatus according to the present exemplary embodiment; and

FIG. 8 is a schematic configuration view showing another example of the image forming apparatus according to the present exemplary embodiment.

### DETAILED DESCRIPTION

Hereinafter, exemplary embodiments of the present invention will be described in detail with reference to the accompanying drawings.

In the present specification, a numerical range described using “to” represents a range including numerical values listed before and after “to” as the minimum value and the maximum value respectively.

Regarding the numerical ranges described in stages in the present specification, the upper limit or lower limit of a numerical range may be replaced with the upper limit or lower limit of another numerical range described in stages. Furthermore, in the present specification, the upper limit or lower limit of a numerical range may be replaced with values described in examples.

In the present specification, the term “step” includes not only an independent step but a step that is not clearly distinguished from other steps as long as the purpose of the step is achieved.

In the present specification, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present specification, each component may include a plurality of corresponding substances. In a case where the amount of each component in a composition is mentioned in the present exemplary embodiments, and there are two or more kinds of substances corresponding to each component in the composition, unless otherwise specified, the amount of each component means the total amount of two or more kinds of the substances present in the composition.

In the present specification, each component may include two or more kinds of corresponding particles. In a case where a plurality of kinds of particles corresponding to each component are present in a composition, the particle diameter of each component indicates the value of a mixture of the plurality of kinds of particles present in the composition, unless otherwise specified.

In the present specification, an alkyl group and an alkylene group include all linear, branched, and cyclic shapes unless otherwise specified.

In the present specification, a hydrogen atom in an organic group, an aromatic ring, a linking group, an alkyl group, an alkylene group, an aryl group, an aralkyl group, an alkoxy group, an aryloxy group, and the like may be substituted with a halogen atom.

In the present specification, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present specification, “constitutional unit” of a copolymer or a resin is the same as a monomer unit.

In the present specification, ppm stands for parts per million and is on a mass basis.

### Image Forming Apparatus

An image forming apparatus according to the present exemplary embodiment includes an electrophotographic photoreceptor, and a charging device including a charging member that charges a surface of the electrophotographic photoreceptor and a cleaning member that is disposed in contact with the charging member, in which the electrophotographic photoreceptor has a conductive substrate and a photosensitive layer disposed on the conductive substrate, and an outermost surface layer of the electrophotographic photoreceptor contains a charge transport material and a polyarylate resin having a dicarboxylic acid unit represented by Formula (A) and a diol unit represented by Formula (B), the cleaning member has a core metal and a foamed elastic layer provided in a helical shape on an outer peripheral surface of the core metal, and a value of a ratio T/W of a thickness T of the foamed elastic layer to a width W of the foamed elastic layer is 0.6 or more and 1.2 or less.

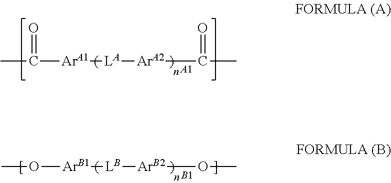

In Formula (A), Ar^{A1} and Ar^{A2} are each independently an aromatic ring which may have a substituent, L^{A} is a single bond or a divalent linking group, and n^{A1} is 0, 1, or 2.

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2. Where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

In the image forming apparatus of the related art, in a case where the contaminated substance of the charging member is continuously pressed by the cleaning member, the adhesion (filming) of the contamination progresses.

In addition, in the image forming apparatus of the related art, abrasion of the photoreceptor occurs frequently.

The mechanism due to which in the electrophotographic photoreceptor according to the present exemplary embodiment, the outermost surface layer of the electrophotographic photoreceptor contains a charge transport material and a polyarylate resin having a dicarboxylic acid unit represented by Formula (A) and a diol unit represented by Formula (B), and the cleaning member has a core metal and a foamed elastic layer provided in a helical shape on an outer peripheral surface of the core metal, and a value of a ratio T/W of a thickness T of the foamed elastic layer to a width W of the foamed elastic layer is 0.6 or more and 1.2 or less is estimated as follows. The polyarylate resin suppresses abrasion of the photoreceptor, and the use of the cleaning member causes a contact pressure to be generated in both the continuous portion and the intermittent portion, which is excellent in contamination removing properties, can suppress filming, and is excellent in contamination-suppressing properties of the charging member.

### Charging Device

The image forming apparatus according to the present exemplary embodiment includes a charging device that includes a charging member for charging a surface of an electrophotographic photoreceptor and a cleaning member that is disposed in contact with the charging member, in which the cleaning member has a core metal and a foamed elastic layer provided in a helical shape on an outer peripheral surface of the core metal, and a value of a ratio T/W of a thickness T of the foamed elastic layer to a width W of the foamed elastic layer is 0.6 or more and 1.2 or less.

### Value of T/W of Foamed Elastic Layer

A value of a ratio T/W of a thickness T of the foamed elastic layer to a width W of the foamed elastic layer is 0.6 or more and 1.2 or less, and from the viewpoint of contamination-suppressing properties of the charging member, for example, preferably 0.60 or more and 1.05 or less, more preferably 0.70 or more and 0.95 or less, and particularly preferably 0.75 or more and 0.90 or less.

The thickness T of the foamed elastic layer is a thickness of a portion of the foamed elastic layer having a smallest thickness.

In addition, as will be described later, in a case where the foamed elastic layer is provided in a double helical shape, a triple helical shape, or the like, for example, it is preferable that each of two or more helical foamed elastic layers satisfies the value of T/W. The width W of the foamed elastic layer is a width of each helical foamed elastic layer.

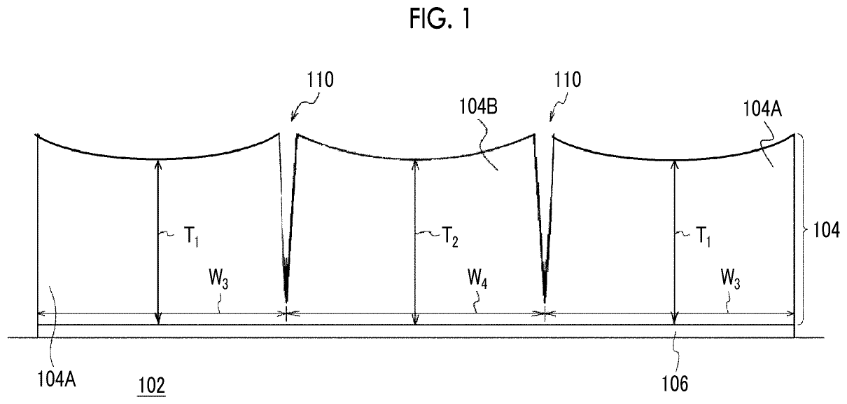

FIG. 1 is an enlarged cross-sectional view showing a foamed elastic layer in an example of a cleaning member used in the present exemplary embodiment. In the cleaning member shown in FIG. 1, three or more divided foamed elastic layers 104 are wound around a core metal 102 in a state of being gathered together via a cut portion 110. As described above, in the divided foamed elastic layer 104, each of the divided foamed elastic layers (104A, 104B) has a protruding portion in which both edge portions in the width direction protrude in a direction radially outward of the core body.

In the cleaning member as shown in FIG. 1, it is preferable that both the thickness T and the width W of each foamed elastic layer, that is, T₁/W₃ and T₂/W₄ in FIG. 1 satisfy, for example, the value of T/W.

From the viewpoint of contamination-suppressing properties of the charging member, the width W of the foamed elastic layer is, for example, preferably 1.0 mm or more and 5.0 mm or less, more preferably 1.5 mm or more and 4.0 mm or less, and particularly preferably 2.0 mm or more and 4.0 mm or less.

From the viewpoint of contamination-suppressing properties of the charging member, the thickness T of the foamed elastic layer is, for example, preferably 1.5 mm or more and 7.0 mm or less, more preferably 2.0 mm or more and 6.0 mm or less, still more preferably 2.5 mm or more and 4.5 mm or less, and particularly preferably 2.5 mm or more and 4.0 mm or less.

The thickness and the width of the foamed elastic layer in the present exemplary embodiment are measured with a laser displacement meter or a caliper.

### Coverage Area Ratio A of Foamed Elastic Layer

From the viewpoint of contamination-suppressing properties of the charging member, the coverage area ratio A of the foamed elastic layer provided on the cleaning member is, for example, preferably 10% by area or more and 70% by area or less, more preferably 20% by area or more and 60% by area or less, and particularly preferably 30% by area or more and 60% by area or less.

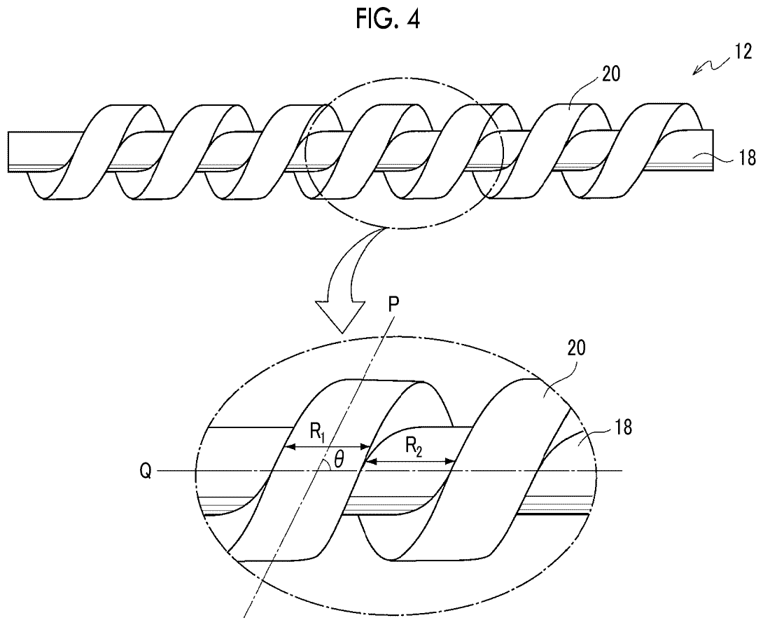

The coverage area ratio A of the foamed elastic layer represents the area ratio of the area covered with the foamed elastic layer to the entire circumferential surface of the core metal. That is, the coverage area ratio A is also represented by a helical width R₁ of a foamed elastic layer 20/[the helical width R₁ of the foamed elastic layer 20+a helical pitch R₂ of the foamed elastic layer 20] in FIG. 4.

### Surface Roughness Rz of Charging Member

From the viewpoint of contamination-suppressing properties of the charging member, the surface roughness Rz of the charging member is, for example, preferably 3 μm or more and 12 μm or less, preferably 5 μm or more and 10 μm or less, and particularly preferably 5 μm or more and 7 μm or less.

The surface roughness Rz of the charging member is measured by a Surfcom roughness meter (manufactured by Tokyo Seimitsu Co., Ltd.).

### Number of Rolls of Foamed Elastic Layer

The foamed elastic layer may have a single helical shape, a double helical shape, a triple helical shape, or the like.

From the viewpoint of contamination-suppressing properties of the charging member, the number of rolls of the foamed elastic layer on the core metal is, for example, preferably 1 or more and 5 or less, more preferably 1 or more and 3 or less, still more preferably 2 or 3, and particularly preferably 3.

The shape of the charging member and the cleaning member according to the present exemplary embodiment is not particularly limited as long as the above-described conditions are satisfied.

Hereinafter, a description of a charging roll and a cleaning member according to the present exemplary embodiment will be made as an example of the charging member, but of course, the constituent materials of each layer of the charging member or the cleaning member are also similarly used for charging members or cleaning members having other shapes.

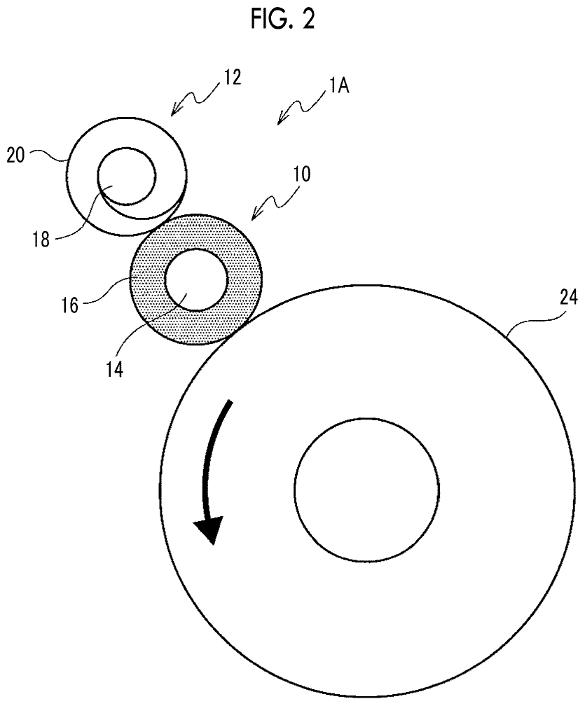

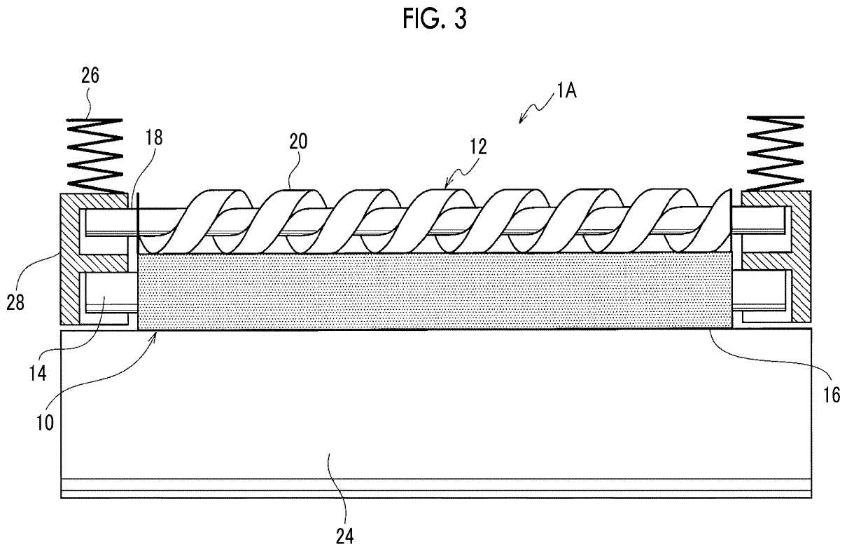

FIG. 2 is a side view showing a schematic configuration of an example of the charging device according to the present exemplary embodiment. In addition, FIG. 3 is a front view showing a schematic configuration of an example of the charging device according to the present exemplary embodiment. FIG. 4 is a schematic side view showing an example of a cleaning member used in the charging device according to the present exemplary embodiment.

A charging device 1A shown in FIGS. 2 and 3 is a charging member that charges a surface of an image carrier provided in an image forming apparatus, and includes a charging roll 10 that is a cylindrical charging member rotating about an axis center, and a cleaning roll 12 that is a cleaning member for cleaning a surface of the charging roll 10 by coming into contact with the charging roll 10.

The charging roll 10 includes, for example, a conductive core body 14 and a charging layer 16 formed on an outer periphery of the conductive core body 14. The charging layer 16 includes, for example, a conductive elastic layer, and a surface layer or the like is formed as necessary.

As shown in FIG. 4, the cleaning roll 12 is a roll-shaped member including a core metal 18 and a foamed elastic layer 20 formed on an outer periphery of the core metal 18, and the foamed elastic layer 20 is disposed in a helical shape on a surface of the core metal 18. Specifically, the foamed elastic layer 20 is disposed, for example, in a state of being helically wound with an axis of the core metal 18 as a helical axis at an interval from one end to the other end of the core metal 18.

As shown in FIG. 3, in the charging device 1A, the charging roll 10 is pressed against the surface of a photoreceptor 24 by an elastic member such as a coil spring 26 installed at both end portions of the conductive core body 14 with respect to the photoreceptor 24 that is an image carrier, and follows the photoreceptor 24. On the other hand, the cleaning roll 12 is held by the bearing 28 at a distance between the conductive core body 14 of the charging roll 10 and the core metal 18 of the cleaning roll 12, and the cleaning roll 12 comes into contact with the charging roll 10 at a predetermined amount of bite (nip) and is driven. The charging roll 10 and the cleaning roll 12 may be driven by the photoreceptor 24 and the charging roll 10, respectively, or may be driven separately.

### Cleaning Member

Hereinafter, each layer and the like constituting the cleaning member such as the cleaning roll 12 will be described. The configuration of the cleaning member is not particularly limited as long as the cleaning member has a cleaning function of a charging member such as a charging roll and satisfies the above-described requirements, and it is preferable that the cleaning member is configured not to cause scratches, contamination, and the like on the surface of the charging roll that appear as image quality.

Examples of a material used for the core metal 18 of the roll-shaped cleaning roll 12 include metals such as free-cutting steel and stainless steel, and resins such as polyacetal (POM). A material, a surface treatment method, and the like of the core metal 18 are selected according to the application such as sliding properties. In particular, in a case where the material of the core metal 18 is metal, a plating treatment may be performed from the viewpoint of rust prevention and the like. In addition, in a case where the material of the core metal 18 is a material such as a resin that does not have conductivity, the core metal 18 may be subjected to a conductivity treatment by being processed by a general treatment such as a plating treatment, or may be used as it is.

The outer diameter of the core metal 18 is, for example, in a range of φ3 mm or more and φ6 mm or less.

The configuration of the foamed elastic layer 20 on the core metal 18 may be a single layer or a laminated configuration of two or more layers. The foamed elastic layer 20 may be configured to include a foaming body, or may be configured to have two layers of a solid layer and a foaming layer. Since the foamed elastic layer 20 is configured such that the surface of the charging member is cleaned, a function as a cleaning roll can be obtained.

As a material constituting the foamed elastic layer 20, a material obtained by mixing one kind of resin or rubber material or two or more kinds of resin or rubber materials may be used, the resin or rubber material including a foaming resin such as polyurethane, polyethylene, polyamide, or polypropylene, or a rubber material such as silicone rubber, fluorine rubber, urethane rubber, ethylene-propylene-diene rubber (EPDM), nitrile rubber (NBR), chloroprene rubber (CR), chlorinated polyisoprene rubber, isoprene rubber, acrylonitrile-butadiene rubber, styrene-butadiene rubber, hydrogenated polybutadiene rubber, or butyl rubber. As necessary, auxiliary agents such as a foaming auxiliary agent, a foam stabilizer, a catalyst, a curing agent, a plasticizer, and a vulcanization accelerator may be added to these.

As a material constituting the foamed elastic layer 20, particularly from the viewpoint of ease of removing foreign matter or the like, for example, a material having air bubbles (so-called a foaming body) is desirable. In particular, in order to prevent the surface of the charging member from being scratched due to rubbing and to prevent tearing, pulling, or the like from occurring over a long period of time, for example, it is preferable to use foamed polyurethane which is strong against tearing, pulling, and the like.

The polyurethane is not particularly limited, and examples thereof include a polyurethane obtained by a reaction between a polyol such as polyester polyol, polyether polyol, or acrylic polyol and an isocyanate such as 2,4-tolylene diisocyanate, 2,6-tolylene diisocyanate, 4,4-diphenylmethane diisocyanate, tolidine diisocyanate, or 1,6-hexamethylene diisocyanate. In addition, a chain extender such as 1,4-butanediol or trimethylolpropane may be mixed. Foaming may be performed using a foaming agent such as water, an azodicarbonamide, or an azo compound such as azobisisobutyronitrile. Further, an auxiliary agent such as a foaming auxiliary agent, a foam stabilizer, or a catalyst may be added as necessary.

In addition, among the above-described foamed polyurethanes, for example, a polyether-based polyurethane (ether-based foamed polyurethane) in which a polyether polyol is used as a raw material of urethane is good, and hydrolysis or the like is less likely to occur as compared with polyester-based polyurethane, and thus the storage stability under a high temperature and high humidity (for example, temperature of 45° C. and humidity of 95%) is good.

Examples of the foam stabilizer include a silicone-based foam stabilizer such as the silicone-based oil.

In particular, in a case of manufacturing a polyether-based polyurethane, since silicone oil is often used as a foam stabilizer, in a case where the polyether-based polyurethane is used as a material of the elastic layer 20, the foamed elastic layer 20 is often included in the silicone oil.

The foamed elastic layer 20 is disposed in a helical shape as shown in FIG. 4, but specific examples thereof include a helical shape in which a helical angle θ is 100 or more and 65° or less (for example, preferably 20° or more and 50° or less).

The helical angle θ means an angle (acute angle) at which the longitudinal direction P (helical direction) of the foamed elastic layer 20 and the axial direction Q (core body axial direction) of the core metal 18 intersect with each other.

The helical width R₁ means a length of the core metal 18 in the axial direction Q (core body axial direction) in the foamed elastic layer 20.

The helical pitch R₂ means a length between the adjacent foamed elastic layers 20 along the axial direction Q (core body axial direction) of the core metal 18 in the foamed elastic layer 20.

In addition, the foamed elastic layer 20 refers to a layer composed of a material that is restored to the original shape even in a case where the layer is deformed due to application of an external force of 100 Pa.

### Charging Member

Next, a charging roll 10 as a charging member will be described, but the present invention is not limited to the following configuration as long as the charging roll 10 has predetermined charging performance to charge an image carrier as a charged body.

The charging roll 10 is configured to include, for example, a conductive core body 14 and a charging layer 16 including an elastic layer or a resin layer. The charging layer 16 may consist of, for example, a single-layer configuration of an elastic layer, or may have a laminated configuration consisting of a plurality of different layers having a plurality of functions. Further, the elastic layer may be subjected to a surface treatment. Here, the “conductivity” means that the volume resistivity at 20° C. is 1×10⁷ Ωcm or less. The same applies hereinafter.

Examples of a material used for the conductive core body 14 include metals such as free cutting steel and stainless steel, and a material, a surface treatment method, and the like may be appropriately selected according to the application of sliding properties and the like. From the viewpoint of rust prevention and the like, the conductive core body 14 may be subjected to a plating treatment. In a case where the material of the conductive core body 14 is a material having no conductivity, a conductivity treatment may be performed by processing the conductive core body 14 by, for example, a general treatment such as a plating treatment, or the conductive core body 14 may be used as it is.

In order to obtain predetermined charging performance, the elastic layer may be used as a conductive elastic layer. Examples of the conductive elastic layer include a layer configured to contain an elastic material such as rubber having elasticity, a conductive material such as carbon black or an ion conductive agent that adjusts the resistance of the conductive elastic layer, and additives such as a softening agent, a plasticizer, a curing agent, a vulcanizing agent, a vulcanization accelerator, an anti-aging agent, silica, and a filler such as calcium carbonate, as necessary. The conductive elastic layer is formed, for example, by coating the peripheral surface of the conductive core body 14 with a mixture of the above-described materials. As a conductive agent for the purpose of adjusting the resistance value, a material in which at least one of electrons or ions such as carbon black or an ion conductive agent, which is blended in a matrix material, is dispersed as a charge carrier, may be used. In addition, the elastic material may be a foam body.

The elastic material constituting the conductive elastic layer is formed, for example, by dispersing a conductive agent in a rubber material. Examples of the rubber material include isoprene rubber, chloroprene rubber, epichlorohydrin rubber, butyl rubber, urethane rubber, silicone rubber, fluororubber, styrene-butadiene rubber, butadiene rubber, nitrile rubber, ethylene-propylene rubber, epichlorohydrin-ethylene oxide copolymer rubber, epichlorohydrin-ethylene oxide-allyl glycidyl ether copolymer rubber, ethylene-propylene-diene terpolymer rubber (EPDM), acrylonitrile-butadiene copolymer rubber, natural rubber, and mixed rubber thereof. Among these, silicone rubber, ethylene propylene rubber, epichlorohydrin-ethylene oxide copolymer rubber, epichlorohydrin-ethylene oxide-allyl glycidyl ether copolymer rubber, acrylonitrile-butadiene copolymer rubber, and a mixed rubber thereof are used. These rubber materials may be foamed or unfoamed.

As the conductive agent, for example, an electron conductive agent or an ion conductive agent is used. Examples of the electronic conductive agent include fine powder, for example, carbon black such as ketjen black or acetylene black; thermally decomposed carbon, graphite; various conductive metals such as aluminum, copper, nickel, and stainless steel or alloys thereof; various conductive metal oxides such as tin oxide, indium oxide, titanium oxide, a tin oxide-antimony oxide solid solution, and a tin oxide-indium oxide solid solution; and a substance obtained by performing a conduction treatment on the surface of an insulating material. In addition, examples of the ionic conductive agent include perchlorates and chlorates such as tetraethylammonium and lauryl trimethylammonium; and alkali metals such as lithium and magnesium, and perchlorates and chlorates of alkaline earth metals.

Such a conductive agent may be used singly or in combination of two or more types. In addition, the amount of the additive is not particularly limited, and in a case of the above-described electron conductive agent, the amount of the additive is, for example, in a range of 1 part by mass or more and 60 parts by mass or less with respect to 100 parts by mass of the rubber material, and in a case of the above-described ion conductive agent, the amount of the additive is, for example, in a range of 0.1 parts by mass or more and 5.0 parts by mass or less with respect to 100 parts by mass of the rubber material.

A surface layer may be formed on the surface of the charging roll 10 in order to prevent contamination by foreign matter such as toner. As the material of the surface layer, any of a resin, rubber, or the like may be used, and the material is not particularly limited. Examples of the resin or rubber include polyester, polyimide, copolymerized nylon, a silicone resin, an acrylic resin, polyvinyl butyral, an ethylene tetrafluoroethylene copolymer, a melamine resin, a fluororubber, an epoxy resin, polycarbonate, polyvinyl alcohol, cellulose, polyvinylidene chloride, polyvinyl chloride, polyethylene, and an ethylene vinyl acetate copolymer.

Among these, from the viewpoint of suppressing contamination of the toner with an external additive or the like, polyvinylidene fluoride, a tetrafluoroethylene copolymer, polyester, polyimide, or copolymerized nylon is used. The copolymerized nylon includes any one or a plurality of kinds of 610 nylon, 11 nylon, or 12 nylon as a polymerized unit, and examples of other polymerized units contained in this copolymer include 6 nylon and 66 nylon. Here, the proportion of the polymerization units such as 610 nylon, 11 nylon, and 12 nylon contained in the copolymer is, for example, preferably 10% or more in terms of mass ratio.

The resin or rubber may be used alone, two or more kinds thereof may be mixedly used, or the resin and the rubber may be mixedly used. In addition, the number-average molecular weight of the resin or rubber is, for example, preferably in a range of 1,000 or more and 100,000 or less and more preferably in a range of 10,000 or more and 50,000 or less.

In addition, the surface layer may contain a conductive material to adjust the resistance value. As the conductive material, for example, a conductive material having a particle diameter of 3 μm or less is preferable.

In addition, as a conductive agent for the purpose of adjusting the resistance value, a material in which at least one of electrons or ions such as carbon black, conductive metal oxide particles, or an ion conductive agent, which is blended in a matrix material, is dispersed as a charge carrier, may be used.

Specific examples of the carbon black of the conductive agent include carbon blacks having a pH of 4.0 or less, such as “SPECIAL BLACK 350”, “SPECIAL BLACK 100”, “SPECIAL BLACK 250”, “SPECIAL BLACK 5”, “SPECIAL BLACK 4”, “SPECIAL BLACK 4A”, “SPECIAL BLACK 550”, “SPECIAL BLACK 6”, “COLOR BLACK FW200”, “COLOR BLACK FW2”, “COLOR BLACK FW2V” manufactured by Degussa AG, “MONARCH 1000”, “MONARCH 1300”, “MONARCH 1400”, “MOGUL-L”, and “REGAL 400R” manufactured by Cabot Corporation.

Examples of the conductive metal oxide particles which are conductive particles for adjusting the resistance value include particles having conductivity such as tin oxide, tin oxide doped with antimony, zinc oxide, anatase-type titanium oxide, and ITO, and any conductive agent in which electrons are charge carriers may be used, and the conductive metal oxide particles are not particularly limited. These may be used alone or in combination of two or more kinds thereof. In addition, the particle diameter may be any particle diameter as long as the effects of the present exemplary embodiment are not impaired, but from the viewpoint of resistance value adjustment, strength, and the like, for example, tin oxide, tin oxide doped with antimony, or anatase type titanium oxide is preferable, and tin oxide or tin oxide doped with antimony is more preferable.

Furthermore, it is preferable that the surface layer uses a fluorine-based or silicone-based resin, and is particularly configured to include, for example, a fluorine-modified acrylate polymer. In addition, particles may be added to the surface layer. As a result, the surface layer acts to be hydrophobic to prevent foreign matter from being attached to the charging roll 10. In addition, insulating particles such as alumina and silica may be added to provide roughness on the surface of the charging roll, and the mutual abrasion resistance between the charging roll and the image carrier may be improved by reducing the load during rubbing with the photoreceptor drum. Here, the “insulating properties” refer to a volume resistivity at 20° C. of 1×10¹³ Ωcm or more. The same applies hereinafter.

The outer diameter of the charging roll 10 is, for example, preferably 8 mm or more and 16 mm or less. From the viewpoint of downsizing the image forming apparatus, for example, φ 14 mm or less is preferable, and in a case where the diameter is 8 mm or less, the number of times of contact with the external additive per one location of the charging roll peripheral surface increases, and the number of discharges increases, which may be disadvantageous for maintaining the charging performance. In addition, as for the method of measuring the outer diameter, the outer diameter may be measured using a commercially available caliper or a laser-type outer diameter measuring device.

The microhardness of the charging roll 10 is, for example, preferably 45° or more and 60° or less. In a case where the hardness is higher than 60°, even in a case where the cleaning member is attached, the contact property with the image carrier is not easily secured, and thus the image quality density unevenness may occur. In a case where the hardness is softer than 45°, the contact with the image carrier is ensured even in a case where the cleaning member is not present. However, a method of increasing the amount of the plasticizer added or a method of using a low-hardness material such as silicone rubber is considered in order to reduce the hardness. In the former case, the plasticizer may bleed, which may cause problems such as deterioration in image quality, and in the latter case, there may be a major increase in cost.

In addition, a value measured by an MD-1 type hardness meter manufactured by KOBUNSHI KEIKI Co., Ltd. may be used as the microhardness of the charging roll 10.

Although the charging roll has been described above as an example of the charging device, the present invention is not limited to a roll-shaped charging device, and for example, a brush-shaped, belt-shaped, or blade-shaped charging device may be used.

### Electrophotographic Photoreceptor

The image forming apparatus according to the present exemplary embodiment includes an electrophotographic photoreceptor (hereinafter, also referred to as a “photoreceptor”), in which the electrophotographic photoreceptor has a conductive substrate and a photosensitive layer disposed on the conductive substrate, and an outermost surface layer of the electrophotographic photoreceptor contains a charge transport material, and a polyarylate resin having a dicarboxylic acid unit represented by Formula (A) and a diol unit represented by Formula (B).

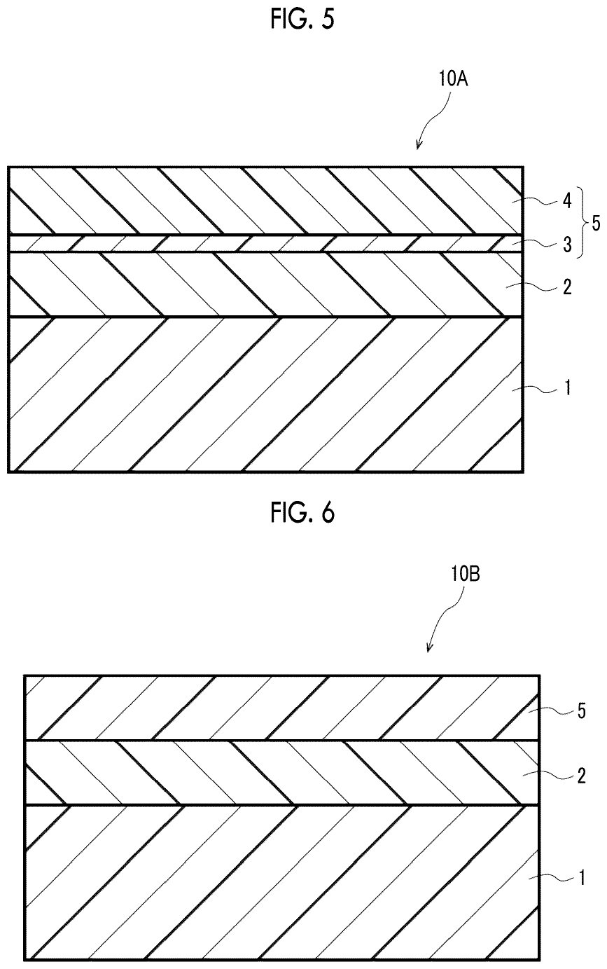

FIG. 5 is a partial cross-sectional view schematically showing an example of a layer configuration of the photoreceptor according to the present exemplary embodiment. A photoreceptor 10A shown in FIG. 5 includes a lamination-type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation-type photosensitive layer). The photoreceptor 10A may include an interlayer (not shown) between the undercoat layer 2 and the charge generation layer 3. The undercoat layer 2 may or may not be provided.

FIG. 6 is a partial cross-sectional view schematically showing another example of the layer configuration of the photoreceptor according to the present exemplary embodiment. A photoreceptor 10B shown in FIG. 6 includes a single layer type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5. The undercoat layer 2 may or may not be provided.

### Outermost Surface Layer

The outermost surface layer of the photoreceptor contains a charge transport material and a polyarylate resin having a dicarboxylic acid unit represented by Formula (A) and a diol unit represented by Formula (B).

Examples of the charge transport material contained in the outermost surface layer include the same compound as the charge transport material contained in the charge transport layer described later. For example, the same applies to the preferred compound.

The polyarylate resin contained in the outermost surface layer includes a polyarylate resin having a dicarboxylic acid unit represented by Formula (A) and a diol unit represented by Formula (B). In the present disclosure, the polyarylate resin is referred to as a polyarylate resin (PA).

The dicarboxylic acid unit (A) is a constitutional unit represented by Formula (A).

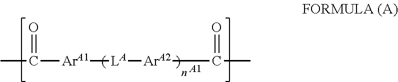

In Formula (A), Ar^{A1} and Ar^{A2} are each independently an aromatic ring which may have a substituent, L^{A} is a single bond or a divalent linking group, and n^{A1} is 0, 1, or 2.

The aromatic ring as Ar^{A1} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{A1} may be substituted with an alkyl group, an aryl group, an aralkyl group, an alkoxy group, an aryloxy group, a halogen atom, or the like. As the substituent in a case where the aromatic ring as Ar^{A1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{A2} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{A2} may be substituted with an alkyl group, an aryl group, an aralkyl group, an alkoxy group, an aryloxy group, a halogen atom, or the like. As the substituent in a case where the aromatic ring as Ar^{A2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

In a case where L^{A} is a divalent linking group, examples of the divalent linking group include an oxygen atom, a sulfur atom, and —C(Ra¹)(Ra²)—. Here, Ra¹ and Ra² are each independently a hydrogen atom, an alkyl group having 1 or more and 10 or less carbon atoms, an aryl group having 6 or more and 12 or less carbon atoms, or an aralkyl group having 7 or more and 20 or less carbon atoms, and Ra¹ and Ra² may be bonded to each other to form a cyclic alkyl group.

The alkyl group having 1 or more and 10 or less carbon atoms, as Ra¹ and Ra², may be linear, branched, or cyclic. The number of carbon atoms of the alkyl group is, for example, preferably 1 or more and 6 or less, more preferably 1 or more and 4 or less, and still more preferably 1 or 2.

The aryl group having 6 or more and 12 or less carbon atoms, as Ra¹ and Ra², may be a monocycle or a polycycle. The number of carbon atoms of the aryl group is, for example, preferably 6 or more and 10 or less and more preferably 6.

An alkyl group of the aralkyl group having 7 or more and 20 or less carbon atoms, as Ra¹ and Ra², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Ra¹ and Ra², may be a monocycle or a polycycle. The number of carbon atoms of the aryl group is, for example, preferably 6 or more and 10 or less and more preferably 6.

The dicarboxylic acid unit (A) preferably includes, for example, at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), a dicarboxylic acid unit (A4) represented by Formula (A4), and a dicarboxylic acid unit (A5) represented by Formula (A5). The dicarboxylic acid unit (A) includes, for example, more preferably at least one selected from the group consisting of a dicarboxylic acid unit (A2), a dicarboxylic acid unit (A3), and a dicarboxylic acid unit (A4) and still more preferably a dicarboxylic acid unit (A2).

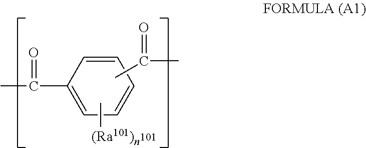

In Formula (A1), n¹⁰¹ is an integer of 0 or greater and 4 or less, and n¹⁰¹ pieces of Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms.

n¹⁰¹ is, for example, preferably 0, 1, or 2, more preferably 0 or 1, and still more preferably 0.

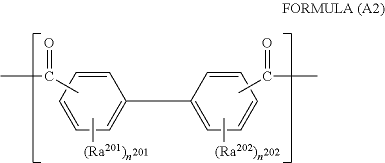

In Formula (A2), n²⁰¹ and n²⁰² are each independently an integer of 0 or greater and 4 or less, and n²⁰¹ pieces of Ra²⁰¹'s and n²⁰² pieces of Ra²⁰²'s are each independently an alkyl group having 1 or more and 10 or less carbon atoms, an aryl group having 6 or more and 12 or less carbon atoms, or an alkoxy group having 1 or more and 6 or less carbon atoms.

n²⁰¹ represents, for example, preferably 0, 1, or 2, more preferably 0 or 1, and still more preferably 0.

n²⁰² represents, for example, preferably 0, 1, or 2, more preferably 0 or 1, and still more preferably 0.

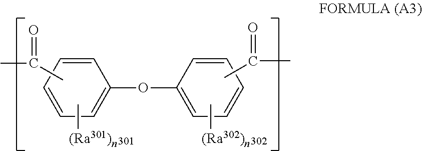

In Formula (A3), n³⁰¹ and n³⁰² are each independently an integer of 0 or greater and 4 or less, and n³⁰¹ pieces of Ra³⁰¹'s and n³⁰² pieces of Ra³⁰²'s are each independently an alkyl group having 1 or more and 10 or less carbon atoms, an aryl group having 6 or more and 12 or less carbon atoms, or an alkoxy group having 1 or more and 6 or less carbon atoms.

n³⁰¹ is, for example, preferably 0, 1, or 2, more preferably 0 or 1, and still more preferably 0.

n³⁰² is, for example, preferably 0, 1, or 2, more preferably 0 or 1, and still more preferably 0.

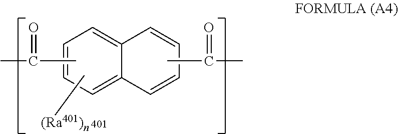

In Formula (A4), n⁴⁰¹ is an integer of 0 or greater and 6 or less, and n⁴⁰¹ pieces of Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms.

n⁴⁰¹ represents, for example, preferably an integer of 0 or greater and 4 or less, more preferably 0, 1, or 2, and still more preferably 0.

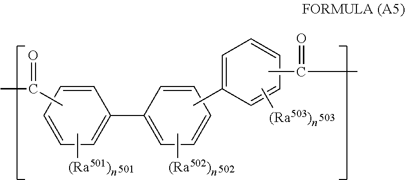

In Formula (A5), n⁵⁰¹, n⁵⁰², and n⁵⁰³ are each independently an integer of 0 or greater and 4 or less, and n⁵⁰¹ pieces of Ra⁵⁰¹'s, n⁵⁰² pieces of Ra⁵⁰²'s, and n⁵⁰³ pieces of Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.
n⁵⁰¹ represents, for example, preferably 0, 1, or 2, more preferably 0 or 1, and still more preferably 0.

n⁵⁰² represents, for example, preferably 0, 1, or 2, more preferably 0 or 1, and still more preferably 0.

n⁵⁰³ represents, for example, preferably 0, 1, or 2, more preferably 0 or 1, and still more preferably 0.

The specific aspects and the preferred aspects of Ra¹⁰¹ in Formula (A1), Ra²⁰¹ and Ra²⁰² in Formula (A2), Ra³⁰¹ and Ra³⁰² in Formula (A3), Ra⁴⁰¹ in Formula (A4), and Ra⁵⁰¹, Ra⁵⁰², and Ra⁵⁰³ in Formula (A5) are the same as each other, and hereinafter, Ra¹⁰¹, Ra²⁰¹, Ra²⁰², Ra³⁰¹, Ra³⁰², Ra⁴⁰¹, Ra⁵⁰¹, Ra⁵⁰², and Ra⁵⁰³ will be collectively referred to as “Ra”.

The alkyl group having 1 or more and 10 or less carbon atoms as Ra may be linear, branched, or cyclic. The number of carbon atoms of the alkyl group is, for example, preferably 1 or more and 6 or less, more preferably 1 or more and 4 or less, and still more preferably 1 or 2.

Examples of the linear alkyl group having 1 or more and 10 or less carbon atoms include a methyl group, an ethyl group, a n-propyl group, a n-butyl group, a n-pentyl group, a n-hexyl group, a n-heptyl group, a n-octyl group, a n-nonyl group, and a n-decyl group.

Examples of the branched alkyl group having 3 or more and 10 or less carbon atoms include an isopropyl group, an isobutyl group, an sec-butyl group, a tert-butyl group, an isopentyl group, a neopentyl group, a tert-pentyl group, an isohexyl group, an sec-hexyl group, a tert-hexyl group, an isoheptyl group, an sec-heptyl group, a tert-heptyl group, an isooctyl group, an sec-octyl group, a tert-octyl group, an isononyl group, an sec-nonyl group, a tert-nonyl group, an isodecyl group, an sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups to which these monocyclic alkyl groups are linked.

The aryl group having 6 or more and 12 or less carbon atoms as Ra may be a monocycle or a polycycle. The number of carbon atoms of the aryl group is, for example, preferably 6 or more and 10 or less and more preferably 6.

Examples of the aryl group having 6 or more and 12 or less carbon atoms include a phenyl group, a biphenyl group, a 1-naphthyl group, and a 2-naphthyl group.

The alkyl group in the alkoxy group having 1 or more and 6 or less carbon atoms as Ra may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Hereinafter, dicarboxylic acid units (A1-1) to (A1-9) are shown as specific examples of the dicarboxylic acid unit (A1). The dicarboxylic acid unit (A1) is not limited thereto.

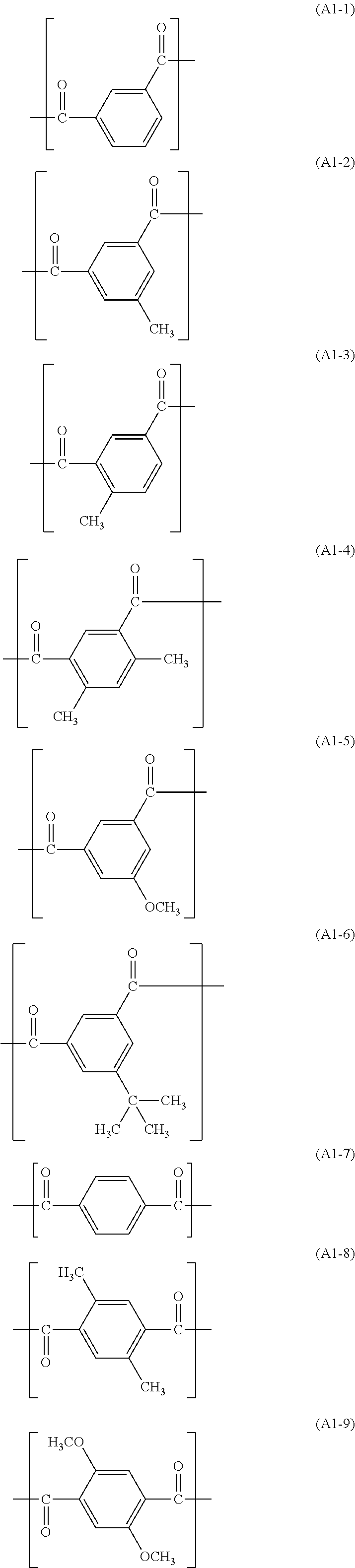

Hereinafter, dicarboxylic acid units (A2-1) to (A2-3) are shown as specific examples of the dicarboxylic acid unit (A2). The dicarboxylic acid unit (A2) is not limited thereto.

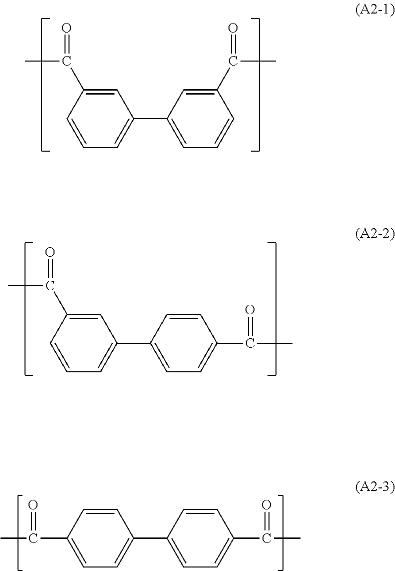

Hereinafter, dicarboxylic acid units (A3-1) and (A3-2) are shown as specific examples of the dicarboxylic acid unit (A3). The dicarboxylic acid unit (A3) is not limited thereto.

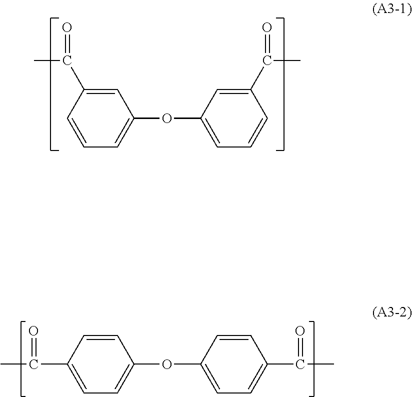

Hereinafter, dicarboxylic acid units (A4-1) to (A4-3) are shown as specific examples of the dicarboxylic acid unit (A4). The dicarboxylic acid unit (A4) is not limited thereto.

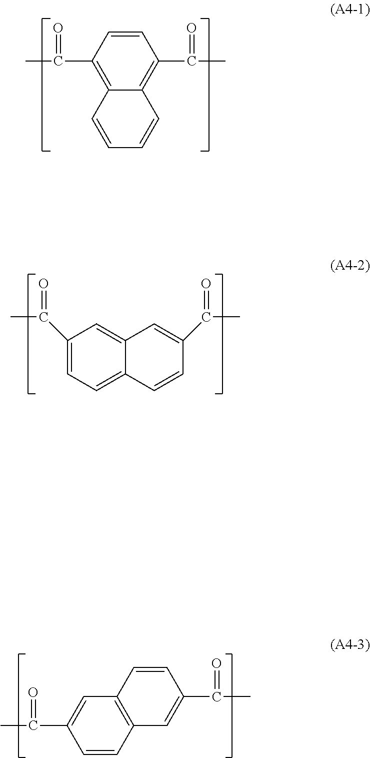

Hereinafter, dicarboxylic acid units (A5-1) to (A5-4) are shown as specific examples of the dicarboxylic acid unit (A5). The dicarboxylic acid unit (A5) is not limited thereto.

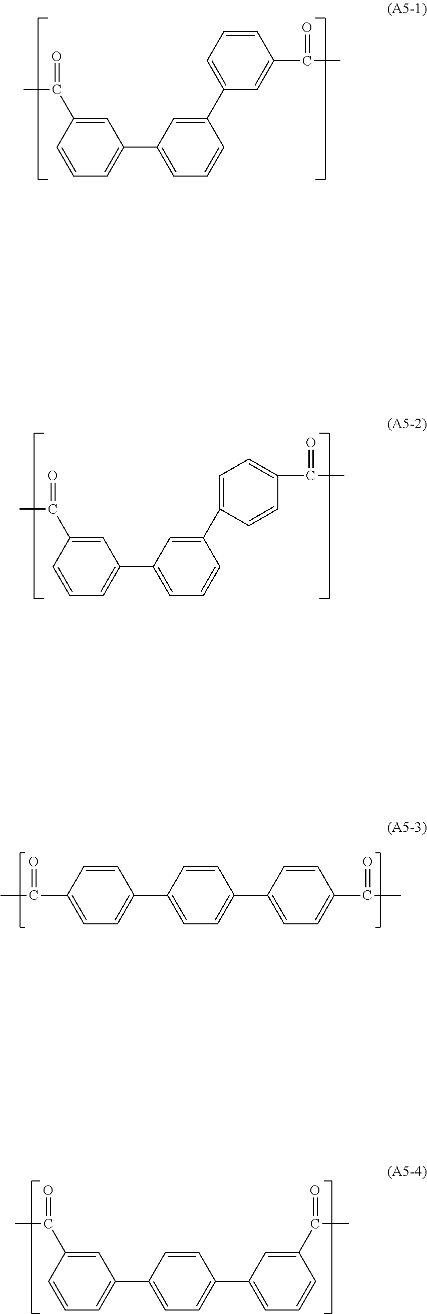

In the above-described specific examples, for example, at least one selected from the group consisting of (A1-1), (A1-7), (A2-3), (A3-2), and (A4-3) is preferably included, at least one selected from the group consisting of (A2-3), (A3-2), and (A4-3) is more preferably included, and at least (A2-3) is still more preferably included as the dicarboxylic acid unit (A).

The dicarboxylic acid unit (A) included in the polyarylate resin (PA) may be used alone or in combination of two or more kinds thereof.

A mass proportion of the dicarboxylic acid unit (A) in the polyarylate resin (PA) is, for example, preferably 15% by mass or more and 60% by mass or less.

In a case where the mass proportion of the dicarboxylic acid unit (A) is 15% by mass or more, the abrasion resistance of the outermost surface layer is enhanced. From the viewpoint, the mass proportion of the dicarboxylic acid unit (A) is, for example, more preferably 20% by mass or more, and still more preferably 25% by mass or more.

In a case where the mass proportion of the dicarboxylic acid unit (A) is 60% by mass or less, peeling of the outermost surface layer can be suppressed. From the viewpoint, the mass proportion of the dicarboxylic acid unit (A) is, for example, more preferably 55% by mass or less, and still more preferably 50% by mass or less.

The polyarylate resin (PA) may have other dicarboxylic acid units in addition to the dicarboxylic acid unit (A). Examples of other dicarboxylic acid units include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower alkyl ester units (for example, having 1 or more and 5 or less carbon atoms) thereof. The dicarboxylic acid units included in the polyarylate resin (PA) may be used alone or in combination of two or more kinds thereof.

The diol unit (B) is a constitutional unit represented by Formula (B).

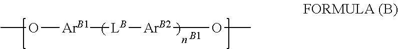

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

The aromatic ring as Ar^{B1} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{B1} may be substituted with an alkyl group, an aryl group, an aralkyl group, an alkoxy group, an aryloxy group, a halogen atom, or the like. As the substituent in a case where the aromatic ring as Ar^{B1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{B2} may be a monocycle or a polycycle. Examples of the aromatic ring include a benzene ring, a naphthalene ring, an anthracene ring, and a phenanthrene ring. Among these, for example, a benzene ring and a naphthalene ring are preferable.

A hydrogen atom on the aromatic ring as Ar^{B2} may be substituted with an alkyl group, an aryl group, an aralkyl group, an alkoxy group, an aryloxy group, a halogen atom, or the like. As the substituent in a case where the aromatic ring as Ar^{B2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The alkyl group having 1 or more and 20 or less carbon atoms, as Rb¹ and Rb², may be linear, branched, or cyclic. The number of carbon atoms of the alkyl group is, for example, preferably 1 or more and 18 or less, more preferably 1 or more and 14 or less, and still more preferably 1 or more and 10 or less.

The aryl group having 6 or more and 12 or less carbon atoms, as Rb¹ and Rb², may be a monocycle or a polycycle. The number of carbon atoms of the aryl group is, for example, preferably 6 or more and 10 or less and more preferably 6.

An alkyl group of the aralkyl group having 7 or more and 20 or less carbon atoms, as Rb¹ and Rb², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Rb¹ and Rb², may be a monocycle or a polycycle. The number of carbon atoms of the aryl group is, for example, preferably 6 or more and 10 or less and more preferably 6.

It is preferable that the diol unit (B) includes, for example, at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

For example, the diol unit (B) more preferably includes at least one selected from the group consisting of the diol unit (B1) represented by Formula (B1), the diol unit (B2) represented by Formula (B2), the diol unit (B4) represented by Formula (B4), the diol unit (B5) represented by Formula (B5), and the diol unit (B6) represented by Formula (B6);
still more preferably includes at least one selected from the group consisting of the diol unit (B1) represented by Formula (B1), the diol unit (B2) represented by Formula (B2), the diol unit (B5) represented by Formula (B5), and the diol unit (B6) represented by Formula (B6);
even more preferably at least one selected from the group consisting of the diol unit (B1) represented by Formula (B1), the diol unit (B2) represented by Formula (B2), and the diol unit (B6) represented by Formula (B6); and
most preferably at least one selected from the group consisting of the diol unit (B1) represented by Formula (B1) and the diol unit (B2) represented by Formula (B2).

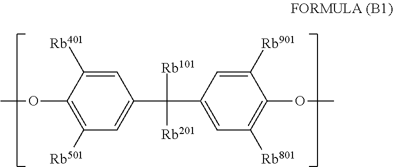

In Formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom.

The number of carbon atoms in the branched alkyl group having 4 or more and 20 or less carbon atoms, as Rb¹⁰¹, is, for example, preferably 4 or more and 16 or less, more preferably 4 or more and 12 or less, and still more preferably 4 or more and 8 or less. Specific examples of Rb¹⁰¹ include an isobutyl group, an sec-butyl group, a tert-butyl group, an isopentyl group, a neopentyl group, a tert-pentyl group, an isohexyl group, an sec-hexyl group, a tert-hexyl group, an isoheptyl group, an sec-heptyl group, a tert-heptyl group, an isooctyl group, an sec-octyl group, a tert-octyl group, an isononyl group, an sec-nonyl group, a tert-nonyl group, an isodecyl group, an sec-decyl group, a tert-decyl group, an isododecyl group, an sec-dodecyl group, a tert-dodecyl group, a tert-tetradecyl group, and a tert-pentadecyl group.

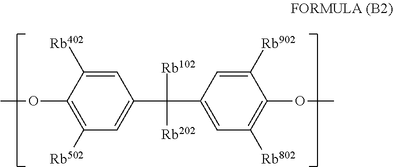

In Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 4 or more and 20 or less carbon atoms, as Rb¹⁰², is, for example, preferably 4 or more and 16 or less, more preferably 4 or more and 12 or less, and still more preferably 4 or more and 8 or less. Specific examples of Rb¹⁰² include an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

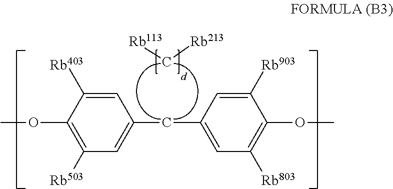

In Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or greater and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹³ and Rb²¹³, is, for example, preferably 1 or 2 and more preferably 1. Specific examples of such a group include a methyl group, an ethyl group, and an n-propyl group.

An alkyl group of the alkoxy group having 1 or more and 4 or less carbon atoms, as Rb¹¹³ and Rb²¹³, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, an sec-butoxy group, a tert-butoxy group, a cyclopropoxy group, and a cyclobutoxy group.

Examples of the halogen atom as Rb¹¹³ and Rb²¹³ include a fluorine atom, a chlorine atom, a bromine atom, and an iodine atom.

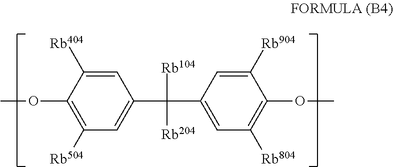

In Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom.

The alkyl group having 1 or more and 3 or less carbon atoms, as Rb¹⁰⁴, may be linear, branched, or cyclic. The number of carbon atoms in the alkyl group is, for example, preferably 1 or 2 and more preferably 1. Specific examples of Rb¹⁰⁴ include a methyl group, an ethyl group, an n-propyl group, an isopropyl group, and a cyclopropyl group.

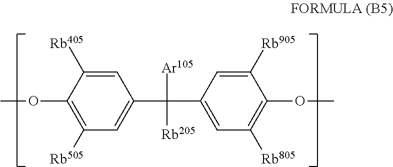

In Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom.

The aryl group having 6 or more and 12 or less carbon atoms, as Ar¹⁰⁵, may be a monocycle or a polycycle. The number of carbon atoms of the aryl group is, for example, preferably 6 or more and 10 or less and more preferably 6.

An alkyl group of the aralkyl group having 7 or more and 20 or less carbon atoms, as Ar¹⁰⁵, may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2. An aryl group of the aralkyl group having 7 or more and 20 or less carbon atoms, as Ar¹⁰⁵, may be a monocycle or a polycycle. The number of carbon atoms of the aryl group is, for example, preferably 6 or more and 10 or less and more preferably 6. Examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

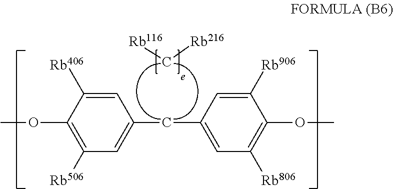

In Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or greater and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹⁶ and Rb²¹⁶, is, for example, preferably 1 or 2 and more preferably 1. Specific examples of such a group include a methyl group, an ethyl group, and an n-propyl group.

An alkyl group of the alkoxy group having 1 or more and 4 or less carbon atoms, as Rb¹¹⁶ and Rb²¹⁶, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, an sec-butoxy group, a tert-butoxy group, a cyclopropoxy group, and a cyclobutoxy group.

Examples of the halogen atom as Rb¹¹⁶ and Rb²¹⁶ include a fluorine atom, a chlorine atom, a bromine atom, and an iodine atom.

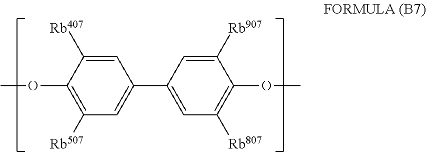

In Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom.

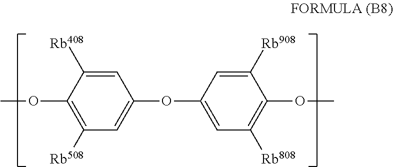

In Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

Specific forms and preferred forms of Rb²⁰¹ in Formula (B1), Rb²⁰² in Formula (B2), Rb²⁰⁴ in Formula (B4), and Rb²⁰⁵ in Formula (B5) are the same as each other, so that Rb²⁰¹, Rb²⁰², Rb²⁰⁴, and Rb²⁰⁵ will be collectively referred to as “Rb²⁰⁰”

The alkyl group having 1 or more and 3 or less carbon atoms, as Rb²⁰⁰, may be linear, branched, or cyclic. The number of carbon atoms in the alkyl group is, for example, preferably 1 or 2 and more preferably 1.

Examples of the alkyl group having 1 or more and 3 or less carbon atoms include a methyl group, an ethyl group, an n-propyl group, an isopropyl group, and a cyclopropyl group.

Specific forms and preferred forms of Rb⁴⁰¹ in Formula (B1), Rb⁴⁰² in Formula (B2), Rb⁴⁰³ in Formula (B3), Rb⁴⁰⁴ in Formula (B4), Rb⁴⁰⁵ in Formula (B5), Rb⁴⁰⁶ in Formula (B6), Rb⁴⁰⁷ in Formula (B7), and Rb⁴⁰⁸ in Formula (B8) are the same as each other, so that Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ will be collectively referred to as “Rb⁴⁰⁰”.

The alkyl group having 1 or more and 4 or less carbon atoms, as Rb⁴⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁴⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁴⁰⁰ include a fluorine atom, a chlorine atom, a bromine atom, and an iodine atom.

Specific forms and preferred forms of Rb⁵⁰¹ in Formula (B1), Rb⁵⁰² in Formula (B2), Rb⁵⁰³ in Formula (B3), Rb⁵⁰⁴ in Formula (B4), Rb⁵⁰⁵ in Formula (B5), Rb⁵⁰⁶ in Formula (B6), Rb⁵⁰⁷ in Formula (B7), and Rb⁵⁰⁸ in Formula (B8) are the same as each other, so that Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ will be collectively referred to as “Rb⁵⁰⁰”.

The alkyl group having 1 or more and 4 or less carbon atoms, as Rb⁵⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁵⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁵⁰⁰ include a fluorine atom, a chlorine atom, a bromine atom, and an iodine atom.

Specific forms and preferred forms of Rb⁸⁰¹ in Formula (B1), Rb⁸⁰² in Formula (B2), Rb⁸⁰³ in Formula (B3), Rb⁸⁰⁴ in Formula (B4), Rb⁸⁰⁵ in Formula (B5), Rb⁸⁰⁶ in Formula (B6), Rb⁸⁰⁷ in Formula (B7), and Rb⁸⁰⁸ in Formula (B8) are the same as each other, so that Rb⁸⁰¹, Rb⁸⁰², Rb⁸⁰³, Rb⁸⁰⁴, Rb⁸⁰⁵, Rb⁸⁰⁶, Rb⁸⁰⁷, and Rb⁸⁰⁸ will be collectively referred to as “Rb⁸⁰⁰”.

The alkyl group having 1 or more and 4 or less carbon atoms, as Rb⁸⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁸⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁸⁰⁰ include a fluorine atom, a chlorine atom, a bromine atom, and an iodine atom.

Specific forms and preferred forms of Rb⁹⁰¹ in Formula (B1), Rb⁹⁰² in Formula (B2), Rb⁹⁰³ in Formula (B3), Rb⁹⁰⁴ in Formula (B4), Rb⁹⁰⁵ in Formula (B5), Rb⁹⁰⁶ in Formula (B6), Rb⁹⁰⁷ in Formula (B7), and Rb⁹⁰⁸ in Formula (B8) are the same as each other, so that Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ will be collectively referred to as “Rb⁹⁰⁰”.

The alkyl group having 1 or more and 4 or less carbon atoms, as Rb⁹⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, an sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁹⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, an sec-butoxy group, a tert-butoxy group, an isopentyloxy group, a neopentyloxy group, a tert-pentyloxy group, an isohexyloxy group, an sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁹⁰⁰ include a fluorine atom, a chlorine atom, a bromine atom, and an iodine atom.

Hereinafter, diol units (B1-1) to (B1-6) are shown as specific examples of the diol unit (B1). The diol unit (B1) is not limited thereto.

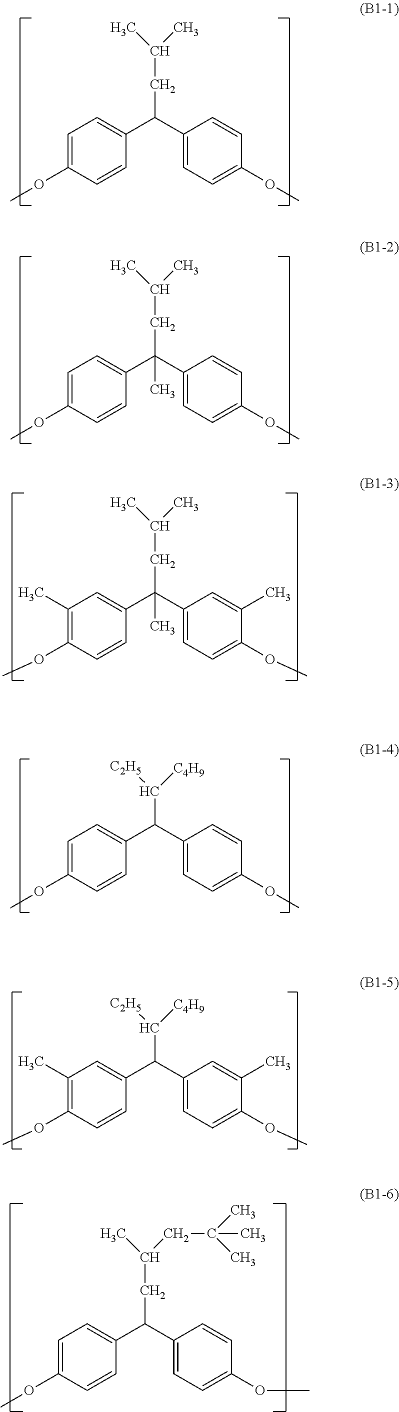

Hereinafter, diol units (B2-1) to (B2-11) are shown as specific examples of the diol unit (B2). The diol unit (B2) is not limited thereto.

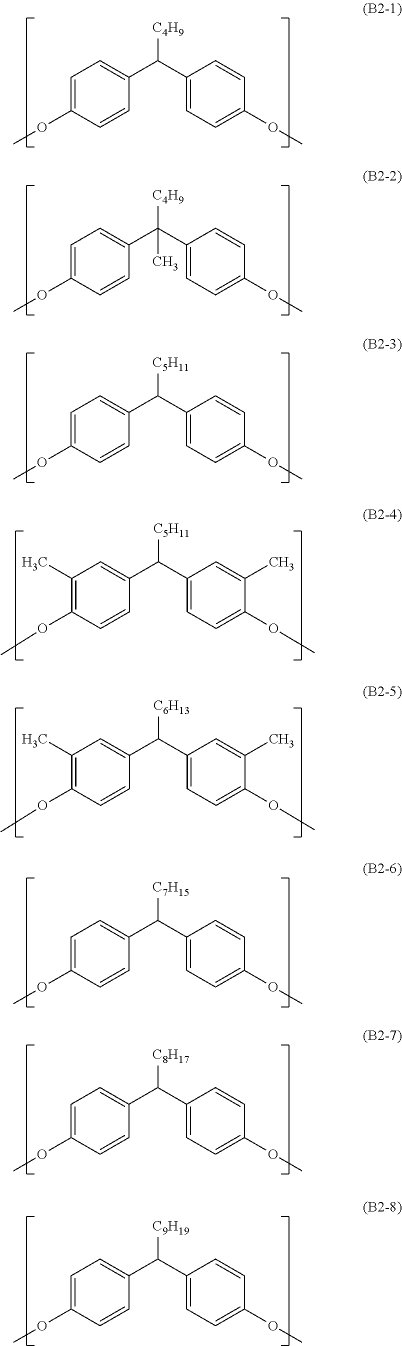

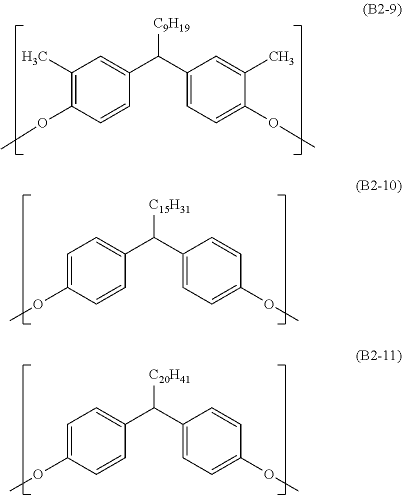

Hereinafter, diol units (B3-1) to (B3-4) are shown as specific examples of the diol unit (B3). The diol unit (B3) is not limited thereto.

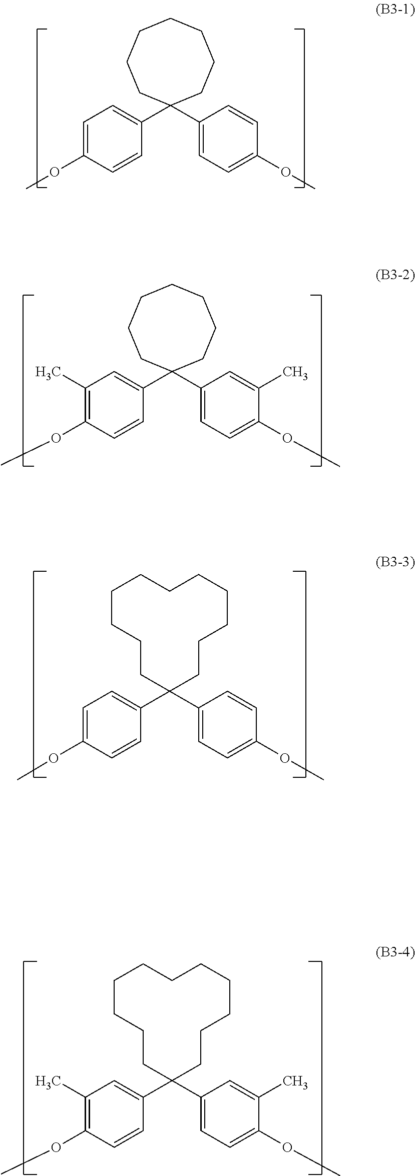

Hereinafter, diol units (B4-1) to (B4-7) are shown as specific examples of the diol unit (B4). The diol unit (B4) is not limited thereto.

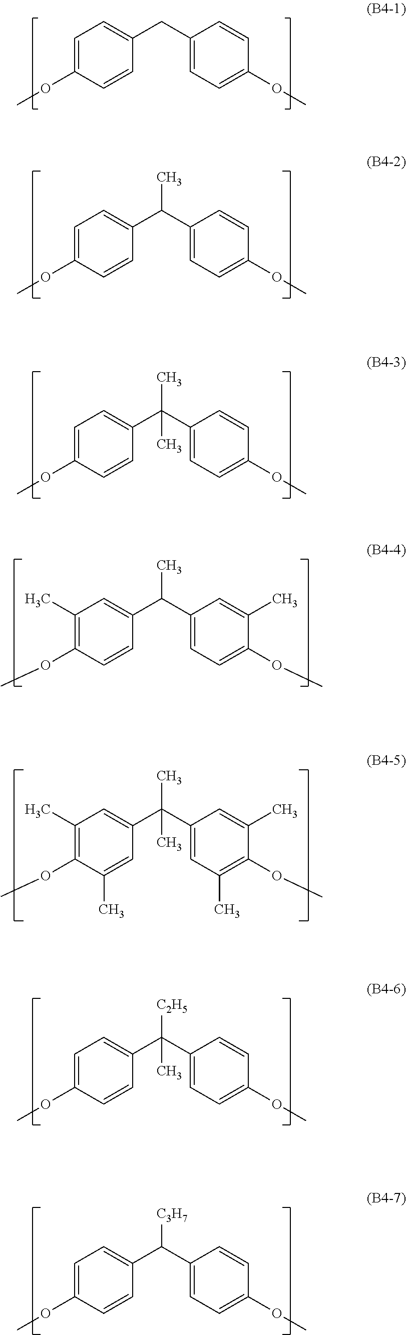

Hereinafter, diol units (B5-1) to (B5-6) are shown as specific examples of the diol unit (B5). The diol unit (B5) is not limited thereto.

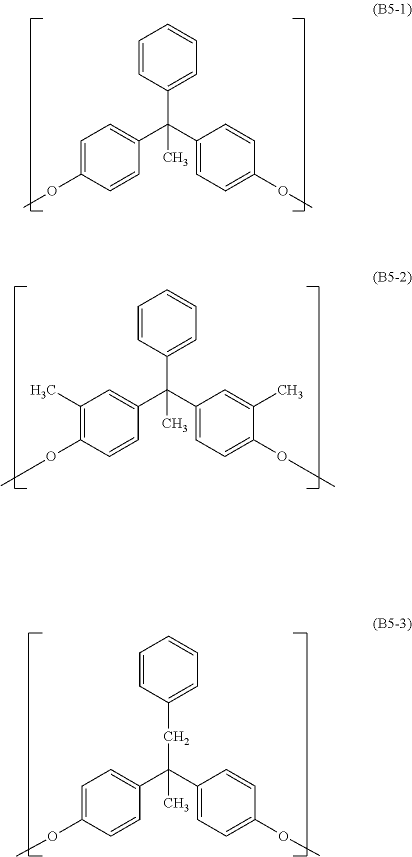

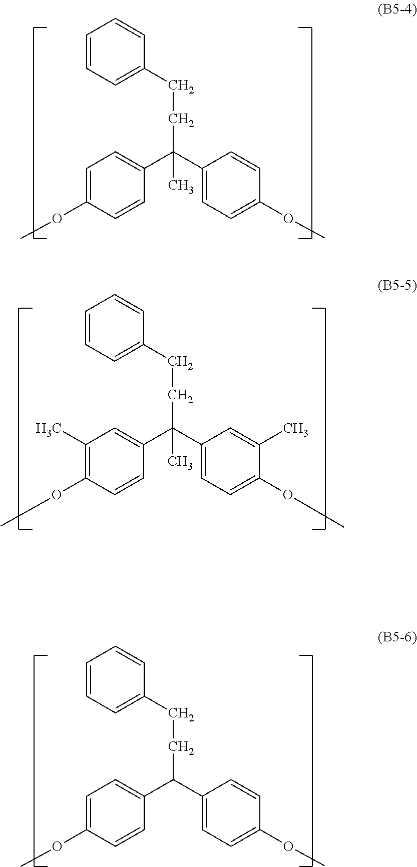

Hereinafter, diol units (B6-1) to (B6-4) are shown as specific examples of the diol unit (B6). The diol unit (B6) is not limited thereto.

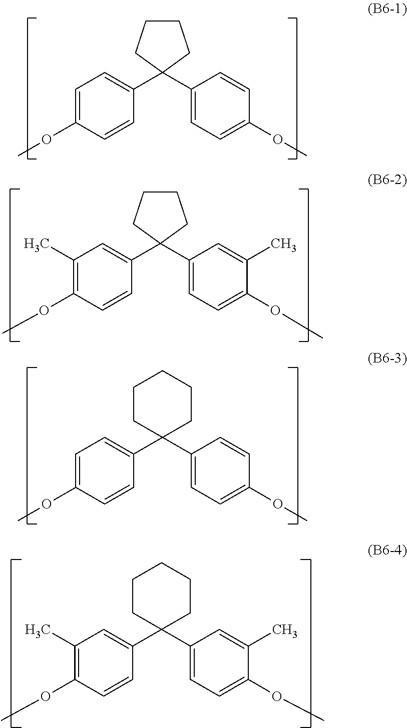

Hereinafter, diol units (B7-1) to (B7-3) are shown as specific examples of the diol unit (B7). The diol unit (B7) is not limited thereto.

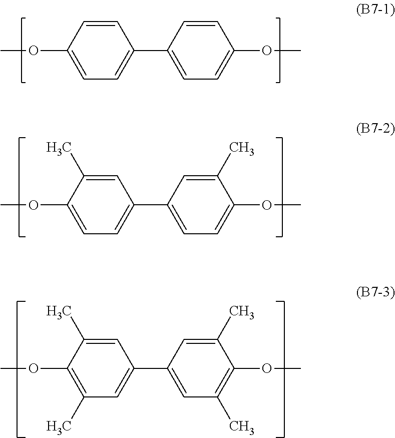

Hereinafter, diol units (B8-1) to (B8-3) are shown as specific examples of the diol unit (B8). The diol unit (B8) is not limited thereto.

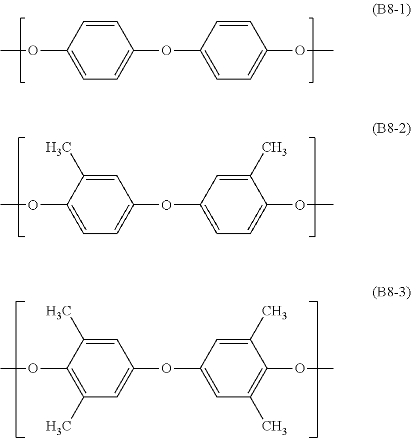

The diol unit (B) included in the polyarylate resin (PA) may be used alone or in combination of two or more kinds thereof.

A mass proportion of the diol unit (B) in the polyarylate resin (PA) is, for example, preferably 25% by mass or more and 80% by mass or less.

In a case where the mass proportion of the diol unit (B) is 25% by mass or greater, peeling of the outermost surface layer can be further suppressed. From the viewpoint, the mass proportion of the diol unit (B) is, for example, more preferably 30% by mass or greater and still more preferably 35% by mass or greater.

In a case where the mass proportion of the diol unit (B) is 80% by mass or less, the solubility in a coating solution for forming the outermost surface layer is maintained, and thus the abrasion resistance can be improved. From the viewpoint, the mass proportion of the diol unit (B) is, for example, more preferably 75% by mass or less and still more preferably 70% by mass or less.

The polyarylate resin (PA) may have other diol units in addition to the diol unit (B). Examples of other diol units include aliphatic diol (such as ethylene glycol, diethylene glycol, triethylene glycol, propylene glycol, butanediol, hexanediol, and neopentyl glycol) units, and alicyclic diol (such as cyclohexanediol, cyclohexanedimethanol, and hydrogenated bisphenol A) units. The diol units included in the polyarylate resin (PA) may be used alone or in combination of two or more kinds thereof.

A terminal of the polyarylate resin (PA) may be sealed or modified with a terminal-sealing agent, a molecular weight modifier, or the like used in a case of the production. Examples of the terminal-sealing agent or the molecular weight modifier include monohydric phenol, monovalent acid chloride, monohydric alcohol, and monovalent carboxylic acid.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of the monovalent acid chloride include monofunctional acid halides such as benzoyl chloride, benzoic acid chloride, methanesulfonyl chloride, phenylchloroformate, acetic acid chloride, butyric acid chloride, octyl acid chloride, benzenesulfonyl chloride, benzenesulfinyl chloride, sulfinyl chloride, benzene phosphonyl chloride, and substituents thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monovalent carboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

The weight-average molecular weight of the polyarylate resin (PA) is, for example, preferably 30,000 or greater and 300,000 or less, more preferably 40,000 or greater and 250,000 or less, and still more preferably 50,000 or greater and 200,000 or less.

The molecular weight of the polyarylate resin (PA) is a molecular weight in terms of polystyrene measured by gel permeation chromatography (GPC). The GPC is carried out by using tetrahydrofuran as an eluent.

The polyarylate resin (PA) can be obtained by polycondensing a monomer providing the dicarboxylic acid unit (A), a monomer providing the diol unit (B), and other monomers as necessary using a method in the related art. Examples of the method of polycondensing monomers include an interfacial polymerization method, a solution polymerization method, and a melt polymerization method. The interfacial polymerization method is a polymerization method of mixing a divalent carboxylic acid halide dissolved in an organic solvent that is incompatible with water and dihydric alcohol dissolved in an alkali aqueous solution to obtain polyester. Examples of documents related to the interfacial polymerization method include W. M. EARECKSON, J. Poly. Sci., XL399, 1959, and JP1965-1959B (JP-S40-1959B). Since the interfacial polymerization method enables the reaction to proceed faster than the reaction carried out by the solution polymerization method and also enables suppression of hydrolysis of the divalent carboxylic acid halide, as a result, a high-molecular-weight polyarylate resin (PA) can be obtained.

Examples of other resins contained in the outermost surface layer include a polyarylate resin other than a polyarylate resin (PA), a polycarbonate resin, a polyester resin other than the polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Two or more kinds of resins may be used in any combination of these resins.

From the viewpoint of abrasion resistance of the outermost surface layer, the resin contained in the outermost surface layer preferably includes, for example, a polyarylate resin and a polycarbonate resin. For example, a form in which a polyarylate resin and a polycarbonate resin are contained is also preferable from the viewpoint of forming a fine phase separation structure in the outermost surface layer.

From the viewpoint of forming a fine phase separation structure in the outermost surface layer, a proportion of the polyarylate resin in a total amount of the polyarylate resin and the polycarbonate resin contained in the outermost surface layer of the photoreceptor is, for example, preferably 20% by mass or more and 80% by mass or less, more preferably 25% by mass or more and 75% by mass or less, and still more preferably 30% by mass or more and 70% by mass or less.

In the polyarylate resin, resin molecules are bonded to each other by an intermolecular force due to stacking of aromatic rings, and thus the abrasion resistance of the outermost surface layer is improved. As the polyarylate resin, for example, a polycondensate of bisphenols and an aromatic divalent carboxylic acid is preferable. Examples of the form of the polyarylate resin include a polyarylate resin (PA) described below.

As the polycarbonate resin, for example, a polycarbonate resin in which constitutional units having an aromatic ring are continuous is preferable. In the polycarbonate resin, resin molecules are bonded to each other by an intermolecular force due to stacking of aromatic rings, and thus the abrasion resistance of the outermost surface layer is improved. For example, preferred aspects of the polycarbonate resin include, specifically, the polycarbonate resin disclosed in JP2023-121553A. For example, a polycarbonate resin used in Examples described later is shown as a more preferred aspect of the polycarbonate resin.

As a combination of the polyarylate resin and the polycarbonate resin, for example, a combination of resins each having a constitutional unit containing a biphenyl represented by Formula (BP) is preferable.

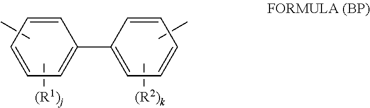

In Formula (BP), j is an integer of 0 or greater and 4 or less, j pieces of R¹'s are each independently a methyl group or an ethyl group, k is an integer of 0 or greater and 4 or less, and k pieces of R²'s are each independently a methyl group or an ethyl group.

The biphenyl represented by Formula (BP) may be an entire structure or a part of a structure obtained by removing an ester bond (—C(═O)O—) or a carbonate bond (—OC(═O)O—) from the constitutional unit including the biphenyl represented by Formula (BP). In other words, the right end and the left end of the biphenyl represented by Formula (BP) may be each independently bonded to an ester bond or a carbonate bond directly or bonded to an ester bond or a carbonate bond via another atom or an atomic group.

j is an integer of 0 or greater and 4 or less, for example, preferably an integer of 0 or greater and 3 or less, more preferably an integer of 0 or greater and 2 or less, still more preferably 0 or 1, and particularly preferably 0.

In a case where j is an integer of 1 or greater, j pieces of R²'s are each independently a methyl group or an ethyl group and, for example, preferably a methyl group.

k is an integer of 0 or greater and 4 or less, for example, preferably an integer of 0 or greater and 3 or less, more preferably an integer of 0 or greater and 2 or less, still more preferably 0 or 1, and particularly preferably 0.

In a case where k is an integer of 1 or greater, k pieces of R²'s are each independently a methyl group or an ethyl group and, for example, preferably a methyl group.

The biphenyl represented by Formula (BP) is, for example, preferably 4,4′-biphenyl with respect to a linking position in a main chain.

As a combination of the polyarylate resin and the polycarbonate resin, for example, a combination of a polyarylate resin having at least one of a dicarboxylic acid unit (A2-3) or a diol unit (B7-1) and a polycarbonate resin having a constitutional unit (Cb7-1) is particularly preferable.

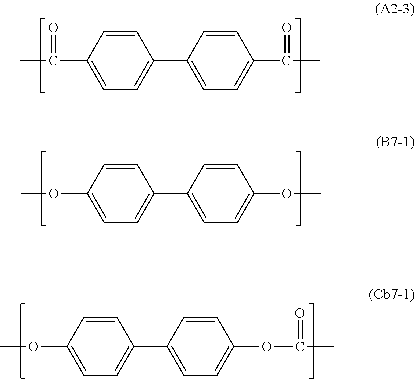

The outermost surface layer preferably further contains, for example, a phenolic compound.

Examples of the phenolic compound contained in the outermost surface layer include phenol, cresol, catechol, resorcinol, hydroquinone, naphthol, and bisphenol (bisphenol A, AP, AF, B, BP, C, C2, E, F, G, M, S, P, PH, TMC, and Z). The phenolic compound may be used alone or in combination of two or more kinds thereof.

Examples of the phenolic compound contained in the outermost surface layer also include a hindered phenolic compound. From the viewpoint of suppressing oxidative deterioration of the outermost surface layer, the phenolic compound contained in the outermost surface layer preferably includes, for example, a hindered phenolic compound. The hindered phenolic compound is generally a compound in which at least one of ortho positions of a hydroxy group of phenol is substituted with a bulky group, and exhibition of an oxidation inhibiting action of the composition is shown.

Examples of the hindered phenolic compound include the following.
Alkylated monophenol compound and derivative thereof: for example, 2,6-di-t-butyl-4-methylphenol, 2,6-di-t-butyl-4-ethylphenol, octyl-3,5-di-t-butyl-4-hydroxy-hydrocinnamate
   Alkylated hydroquinone compound and a derivative thereof: for example, 2,5-di-t-butylhydroquinone, 2,5-di-t-amylhydroquinone
      Alkyl thiomethyl phenol compound and a derivative thereof: for example, 2,4-dioctylthiomethyl-6-t-butylphenol, 2,4-dioctylthiomethyl-6-methylphenol, 2,4-dioctylthiomethyl-6-ethylphenol, and 2,6-didodecylthiomethyl-4-nonylphenol
         Alkylidene bisphenol compound and derivative thereof: for example, 4,4′-butylidenebis(6-t-butyl-3-methylphenol), 2,2′-methylenebis(6-t-butyl-4-methylphenol), 2,2′-methylenebis(6-t-butyl-4-ethylphenol), 2-t-butyl-6-(3-t-butyl-2-hydroxy-5-methylbenzyl)-4-methylphenyl acrylate, and 3,9-bis[2-[3-(3-t-butyl-4-hydroxy-5-methylphenyl)propionyloxy]-1,1-dimethylethyl]-2,4,8,10-tetraoxaspiro[5.5]undecane

Examples of a commercially available product of the hindered phenolic compound include “ADEKA STAB AO-80”, “ADEKA STAB AO-60”, “ADEKA STAB AO-50”, “ADEKA STAB AO-40”, “ADEKA STAB AO-30”, “ADEKA STAB AO-20”, “ADEKA STAB AO-330” (all manufactured by ADEKA Corporation), “Irganox 1010”, “Irganox 245”, “Irganox 1076”, “Irganox 1520” (all manufactured by BASF Japan Ltd.), and “Sumilizer GA-80”, “Sumilizer GM”, and “Sumilizer GS” (all manufactured by Sumitomo Chemical Co., Ltd.).

The hindered phenolic compound may be used alone or in combination of two or more kinds thereof.

From the viewpoint of promoting phase separation of two or more kinds of resins during the formation of the outermost surface layer and forming a fine phase separation structure in the outermost surface layer, a content of the phenolic compound contained in the outermost surface layer is, for example, preferably 0.1% by mass or more and 20% by mass or less, more preferably 0.5% by mass or more and 10% by mass or less, and still more preferably 1% by mass or more and 5% by mass or less with respect to a total mass of the outermost surface layer.

In the outermost surface layer of the photoreceptor, for example, a proportion of the fluororesin particles in the layer is preferably 5% by mass or less, more preferably 1% by mass or less, and still more preferably 0% by mass (that is, the outermost surface layer does not contain the fluororesin particles).

Since there is a high possibility that the regulations on manufacturing and use of the organic fluorine compounds are strengthened in the future, for example, a content of the fluororesin particles is preferably within the above-described range.

A layer thickness of the outermost surface layer may be set according to a function of the layer.

In a case where the charge transport layer is the outermost surface layer, the layer thickness of the outermost surface layer is, for example, preferably 5 μm or more and 50 μm or less, more preferably 8 μm or more and 45 μm or less, and still more preferably 10 μm or more and 40 μm or less.

In a case where the single layer-type photosensitive layer is the outermost surface layer, the layer thickness of the outermost surface layer is, for example, preferably 5 μm or more and 50 μm or less, more preferably 8 μm or more and 45 μm or less, and still more preferably 10 μm or more and 40 μm or less.

A method of forming the outermost surface layer is the same as a method of forming the charge transport layer and a method of forming the single layer-type photosensitive layer, which will be described later.

Hereinafter, each layer of the photoreceptor will be described in detail.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 1×10¹³ Ω·cm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary, and it is suitable for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that the fine pores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. The film thickness of the coating film is, for example, preferably 0.3 μm or greater and m or less.

The boehmite treatment is carried out, for example, by dipping the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. A film thickness of the coating film is, for example, preferably 0.1 m or more and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, the silane coupling agent having an amino group and other silane coupling agents may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound such as 4-hydroxybenzophenone or 2,3,4-trihydroxybenzophenone.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, 4-ethoxy-1,2-hydroxy-9,10-anthraquinone, or a derivative thereof is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that the electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound is, for example, preferably 0.01% by mass or more and 20% by mass or less and more preferably 0.01% by mass or more and 10% by mass or less with respect to the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin, a zirconium chelate compound, a titanium chelate compound, an aluminum chelate compound, a titanium alkoxide compound, an organic titanium compound, and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additive include known materials such as an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

For example, the surface roughness (ten-point average roughness) of the undercoat layer may be adjusted to 1/2 from 1/(4n) (n is a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

The layer thickness of the undercoat layer is set to be, for example, preferably 15 μm or greater and more preferably in a range of 20 μm or greater and 50 μm or less.

### Interlayer

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical methods such as a dip coating method, a push-up coating method, a wire bar coating method, a spray coating method, a blade coating method, an air knife coating method, and a curtain coating method.

The layer thickness of the interlayer is set to be, for example, preferably in a range of 0.1 μm or greater and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is preferable in a case where an incoherent light source such as a light emitting diode (LED) and an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine, chlorogallium phthalocyanine, dichloro-tin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 1×10¹³ Ω·cm or more. These binder resins are used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type homogenizer in which a dispersion liquid is dispersed by a liquid-liquid collision or a liquid-wall collision in a high-pressure state, and a penetration type homogenizer in which a dispersion liquid is dispersed by penetrating the liquid through a fine flow path in a high-pressure state. During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The layer thickness of the charge generation layer is set to be, for example, preferably in a range of 0.1 μm or greater and 5.0 μm or less and more preferably in a range of 0.2 μm or greater and 2.0 μm or less.

### Charge Transport Layer

The charge transport layer is, for example, a layer containing a binder resin and a charge transport material. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. These charge transport materials are used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

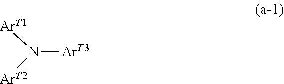

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

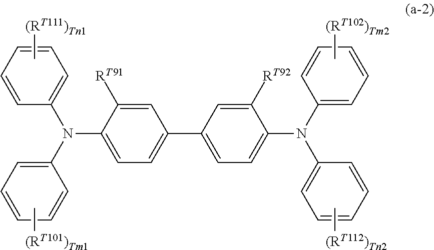

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” or a benzidine derivative having “—CH═CH—CH═C(R^{T15})(R^{T16})” is particularly preferable from the viewpoint of the charge mobility.

As the polymer charge transport material, known materials having charge transport properties, such as poly-N-vinylcarbazole and polysilane, are used. In particular, for example, a polyester-based polymer charge transport material is particularly preferable. The polymer charge transport material may be used alone or in combination of the binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins are used alone or in combination of two or more kinds thereof.

A blending ratio between the charge transport material and the binder resin is, for example, preferably 10:1 to 1:5 in terms of mass ratio.

In a case where the charge transport layer is the outermost surface layer of the photoreceptor, the charge transport layer contains at least two kinds of resins. In a case where the charge transport layer is the outermost surface layer of the photoreceptor, the charge transport layer preferably contains, for example, at least one of a polyarylate resin or a polycarbonate resin, and more preferably contains a polyarylate resin and a polycarbonate resin. As a combination of the polyarylate resin and the polycarbonate resin, for example, a combination of resins each having a constitutional unit containing a biphenyl represented by Formula (BP) is preferable. As the polyarylate resin, for example, a polyarylate resin (PA) is preferable.

In a case where the charge transport layer is the outermost surface layer of the photoreceptor, the charge transport layer contains a phenolic compound. A form of the phenolic compound is as described above.

The charge transport layer may also contain other known additives.

The formation of the charge transport layer is not particularly limited, and a known formation method is used. For example, the charge transport layer is obtained by forming a coating film of a coating solution for forming a charge transport layer, which is obtained by adding the above-described components to a solvent, drying the coating film, and heating the coating film as necessary.

Examples of the solvent for preparing the coating solution for forming the charge transport layer include typical organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

The layer thickness of the charge transport layer is, for example, preferably set in a range of 5 μm or more and 50 μm or less, more preferably set in a range of 8 μm or more and 45 μm or less, and still more preferably set in a range of 10 μm or more and 40 μm or less.

### Single Layer Type Photosensitive Layer

The single layer-type photosensitive layer (charge generation/charge transport layer) is, for example, a layer containing a charge generation material, a charge transport material, and as necessary, a binder resin and other known additives. These materials are the same as the materials described in the sections of the charge generation layer and the charge transport layer.

The content of the charge generation material in the single layer type photosensitive layer is, for example, preferably 0.1% by mass or greater and 10% by mass or less and more preferably 0.8% by mass or greater and 5% by mass or less with respect to the total solid content. In addition, a content of the charge transport material in the single layer type photosensitive layer is, for example, preferably 5% by mass or more and 50% by mass or less with respect to the total solid content.

The method of forming the single layer-type photosensitive layer is the same as the method of forming the charge generation layer or the charge transport layer.

The average layer thickness of the single layer type photosensitive layer is, for example, preferably 5 μm or greater and 50 μm or less, more preferably 8 μm or greater and 45 μm or less, and still more preferably 10 μm or greater and 40 μm or less.

In a case where the single layer-type photosensitive layer is the outermost surface layer of the photoreceptor, the single layer-type photosensitive layer contains at least two resins. In a case where the single layer-type photosensitive layer is the outermost surface layer of the photoreceptor, the single layer-type photosensitive layer preferably contains, for example, at least one of a polyarylate resin or a polycarbonate resin, and more preferably contains a polyarylate resin and a polycarbonate resin. As a combination of the polyarylate resin and the polycarbonate resin, for example, a combination of resins each having a constitutional unit containing a biphenyl represented by Formula (BP) is preferable. As the polyarylate resin, for example, a polyarylate resin (PA) is preferable.

In a case where the single layer-type photosensitive layer is the outermost surface layer of the photoreceptor, the single layer-type photosensitive layer contains a phenolic compound. A form of the phenolic compound is as described above.

As the image forming apparatus according to the present exemplary embodiment, known image forming apparatuses such as an apparatus including a fixing device that fixes a toner image transferred to the surface of a recording medium; a direct transfer type apparatus that transfers a toner image formed on the surface of an electrophotographic photoreceptor directly to a recording medium; an intermediate transfer type apparatus that primarily transfers a toner image formed on the surface of an electrophotographic photoreceptor to the surface of an intermediate transfer member and secondarily transfers the toner image transferred to the surface of the intermediate transfer member to the surface of a recording medium; an apparatus including a charge erasing device that erases the charges on the surface of the electrophotographic photoreceptor by applying the charge erasing light after the transfer of the toner image and before the charging; and an apparatus including an electrophotographic photoreceptor heating member for increasing the temperature of an electrophotographic photoreceptor and decreasing the relative temperature are employed.

In a case of the intermediate transfer-type apparatus, for example, the transfer device has a configuration including an intermediate transfer member with a surface on which the toner image will be transferred, a primary transfer device that performs primary transfer to transfer the toner image formed on the surface of the electrophotographic photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

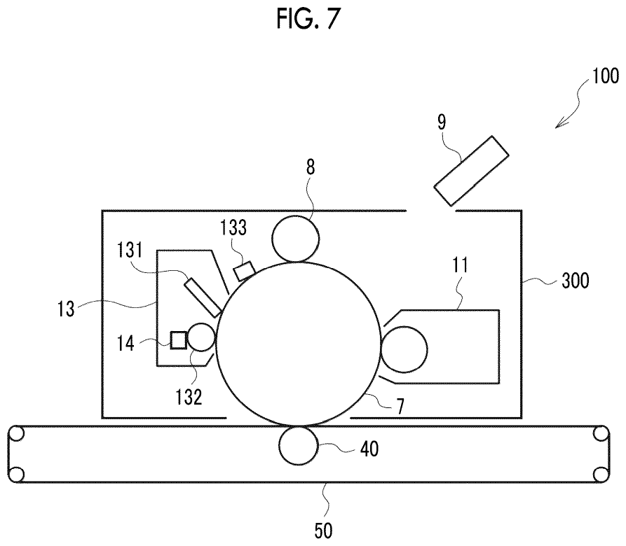

FIG. 7 is a schematic configuration view showing an example of an image forming apparatus according to the present exemplary embodiment.

As shown in FIG. 7, an image forming apparatus 100 according to the present exemplary embodiment includes a process cartridge 300 including an electrophotographic photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 7 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and a cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 7 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, the above-described charging device is used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used. In addition to the cleaning blade type device, a fur brush cleaning type device or a simultaneous development cleaning type device may be employed.

### Transfer Device

Examples of the transfer device 40 include transfer chargers known per se such as a contact-type transfer charger formed of a belt, a roller, a film, and a rubber blade, a scorotron transfer charger using corona discharge, and a corotron transfer charger.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

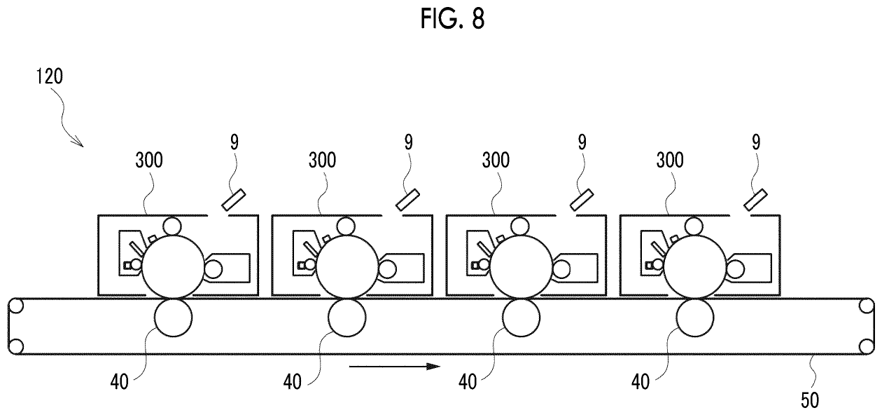

FIG. 8 is a schematic configuration view showing an example of an image forming apparatus according to the present exemplary embodiment.

An image forming apparatus 120 shown in FIG. 8 is a tandem type multicolor image forming apparatus in which four process cartridges 300 are mounted. The image forming apparatus 120 is configured such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### EXAMPLES

Hereinafter, exemplary embodiments of the invention will be described in detail based on examples, but the exemplary embodiments of the invention are not limited to the examples.

In the following description, “parts” and “%” are on a mass basis unless otherwise specified.

In the following description, the synthesis, the treatment, the production, and the like are carried out at room temperature (25° C.±3 C) unless otherwise specified.

### Synthesis of Polyarylate Resin

Polyarylate resins (1-1) to (1-6) are prepared. Table 1 shows units and formulations constituting the polyarylate resins.

Table 1 shows “constitutional unit:compositional ratio” (for example, A2-3:50). The compositional ratio is in units of mol % of each of the dicarboxylic acid unit and the diol unit.

A2-3 and the like listed in Table 1 are specific examples of the dicarboxylic acid unit (A) described above.

B1-4 and the like listed in Table 1 are specific examples of the diol unit (B) described above.

### Example 1

### Production of Photoreceptor Including Lamination-Type Photosensitive Layer

### Formation of Undercoat Layer

As a conductive substrate, an aluminum cylindrical tube is prepared.

3.5 parts of a butyral resin (trade name: S-LEC BM-1, manufactured by Sekisui Chemical Co., Ltd.) and 41 parts of methyl ethyl ketone are mixed and dissolved. 10 parts of a curing agent (blocked isocyanate, trade name: SUMIDUR 3175, manufactured by Sumitomo Bayer Urethane Co., Ltd.), 45.5 parts of zinc oxide (trade name: SMZ-017N, TAYCA Corporation) surface-treated with a silane coupling agent (trade name: KBM603, manufactured by Shin-Etsu Chemical Co., Ltd.), and 0.27 parts of 4-ethoxy-1,2-hydroxy-9,10-anthraquinone are added and stirred, and then the mixture is dispersed for 2 hours with a sand mill using glass beads having a diameter of 1 mm. Further, 0.01 parts of dioctyl tin dilaurate and 2 parts of silicone resin particles (trade name: Tospearl 145, manufactured by GE Toshiba Silicones) are added thereto and stirred, thereby obtaining a coating solution for forming an undercoat layer. The outer peripheral surface of the conductive substrate is coated with the coating solution for forming an undercoat layer by dip coating, and dried and cured at 170° C. for 40 minutes to form an undercoat layer with a layer thickness of 20 km.

### Formation of Charge Generation Layer

A mixture consisting of 15 parts of hydroxygallium phthalocyanine as a charge generation substance (Bragg angle (2θ±0.2°) of the X-ray diffraction spectrum using Cuka characteristic X-ray has diffraction peaks at least positions of 7.5°, 9.9°, 12.5, 16.3°, 18.6°, 25.1°, and 28.3°), 10 parts of a vinyl chloride-vinyl acetate copolymer resin (trade name: VMCH, manufactured by Nippon Unicar Company Limited) as a binder resin, and 200 parts of n-butyl acetate is dispersed in a sand mill for 4 hours using glass beads having a diameter of 1 mm. 175 parts of n-butyl acetate and 180 parts of methyl ethyl ketone are added to the dispersion liquid, and the mixture is stirred to obtain a coating solution for forming a charge generation layer. The undercoat layer is dipped and coated with the coating solution for forming a charge generation layer, and dried at room temperature (25° C.±3 C) to form a charge generation layer having an average thickness of 0.18 μm.

### Formation of Charge Transport Layer

42 parts of the polyarylate resin (1-1) and 18 parts of a polycarbonate resin PC-1 as binder resins, and 40 parts of CTM-1 as a charge transport material are dissolved in 270 parts of tetrahydrofuran and 30 parts of toluene, thereby obtaining a coating solution for forming a charge transport layer. The charge generation layer is dipped and coated with the coating solution for forming a charge transport layer, and dried at 145° C. for 30 minutes to form a charge transport layer. The average thickness As of the charge transport layer is as listed in Table 1.

The polycarbonate resin PC-1 is a resin consisting of the following constitutional repeating units. The number attached to the constitutional unit represents a molar ratio.

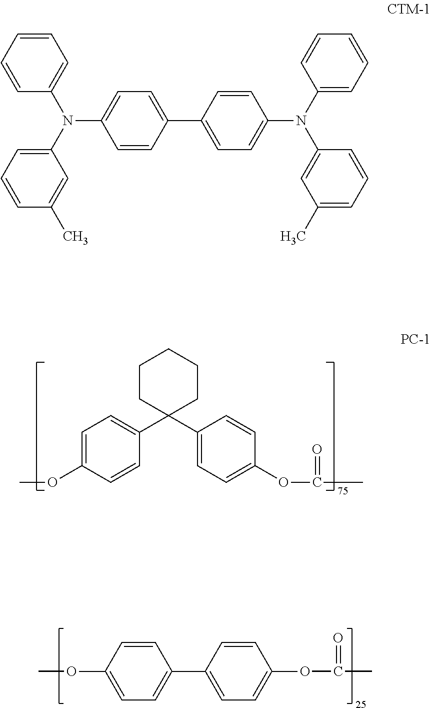

### Production of Cleaning Roll

A urethane foam (EP-70; manufactured by INOAC Corporation) sheet having a thickness of 2.5 mm is cut into strips having a width of 3.0 mm. A double-sided tape (manufactured by Nitto Denko Corporation, No. 5605) having a thickness of 0.05 mm is attached to the entire surface of the cut strip to obtain a strip with a double-sided tape.

The obtained strip with a double-sided tape is placed on a horizontal table such that the release paper attached to the double-sided tape faces downward. Then, the longitudinal end part is compressed from the upper part with stainless steel heated such that the thickness of the range of length of 1 mm in the longitudinal direction from the longitudinal end part of the strip is 15% of the thickness of the other part.

The three strips with the double-sided tape obtained are placed on a horizontal table such that the release paper attached to the double-sided tape is facing upward, and are wound around a core metal (material: SUM24EZ, outer diameter: φ5.0 mm) while applying a tension such that the helical angle θ is 250 and the entire length of the strip is in a range of 0% to 5%.

By the above-described steps, a cleaning roll having a helical shape wound around the outer peripheral surface of the core metal and having a foamed elastic layer is obtained.

### Preparation of Charging Roll

### Formation of Elastic Layer

The following mixture is kneaded with an open roll, coated in a cylindrical shape to have a thickness of 1.5 mm on an outer peripheral surface of a conductive core body having a diameter of 9 mm consisting of SUS416, placed in a cylindrical mold having an inner diameter of 12.0 mm, vulcanized at 170° C. for 30 minutes, taken out from the mold, and polished. In this manner, a cylindrical conductive elastic layer is obtained.
Rubber material (epichlorohydrin-ethylene oxide-allyl glycidyl ether copolymerized rubber, GECHRON 3106, manufactured by ZEON CORPORATION): 100 parts by mass
Conductive agent (carbon black Asahi Thermal, manufactured by Asahi Carbon Co., Ltd.): 25 parts by mass
Conductive agent (Ketchen Black EC, manufactured by Lion Corporation): 8 parts by mass
Ion conductive agent (lithium perchlorate): 1 part by mass
   Vulcanizing agent (sulfur, 200 mesh, manufactured by Tsurumi Chemical Industry Co., Ltd.): 1 part by mass
   Vulcanization accelerator (Nocceler DM, manufactured by Ouchi Shinko Chemical Industrial Co., Ltd.): 2.0 parts by mass
   Vulcanization accelerator (Nocceler TT, manufactured by Ouchi Shinko Chemical Industrial Co., Ltd.): 0.5 parts by mass

### Formation of Surface Layer

The following mixture is dispersed with a beads mill, the obtained dispersion liquid is diluted with methanol, and the surface (outer peripheral surface) of the conductive elastic layer is dipped and coated therewith, and then heated and dried at 140° C. for 15 minutes. In this manner, a charging roll having a surface layer with a thickness of 4 μm is obtained.
Polymer material (copolymerized nylon, AMILAN CM8000, manufactured by Toray Industries, Inc.): 100 parts by mass
Conductive agent (antimony-doped tin oxide, SN-100P, manufactured by Ishihara Sangyo Kaisha, Ltd.): 30 parts by mass
Solvent (methanol): 500 parts by mass
Solvent (butanol): 240 parts by mass Evaluation of Abrasion Resistance of Photoreceptor

The obtained electrophotographic photoreceptor, charging roll, and cleaning roll are mounted on an image forming apparatus “Apeos Port-V C₇₇₇₆ manufactured by FUJIFILM Business Innovation Corp.”.

Using the image forming apparatus, 100,000 sheets of an image having an image average density (area coverage) of 10% are formed on A3-sized paper in an environment of a temperature of 28° C. and a relative humidity of 85%, and then 100,000 sheets are formed in the same manner in an environment of a temperature of 10° C. and a relative humidity of 15%. An average thickness TBEFORE (μm) of the outermost surface layer before the image formation and an average thickness TAFTER (μm) of the outermost surface layer after the image formation are obtained, and a difference ΔT (=TBEFORE—TAFTER) is defined as an amount of abrasion. PERMASCOPE manufactured by Fisher Instruments K. K. is used as a film thickness measuring machine. The contact line pressure of the cleaning blade with respect to the surface of the electrophotographic photoreceptor in the image forming apparatus is set to 2.6 gf/mm, and the contact angle is set to 11 degrees. The amount of abrasion is evaluated according to the following standard. S to C are within an allowable range. The results are shown in Table 1.

### Evaluation Standard

S: amount of abrasion is less than 15 μm.
A: amount of abrasion is 15 μm or more and less than 20 μm.
B: amount of abrasion is 20 μm or more and less than 25 μm.
C: amount of abrasion is 25 μm or more and less than 30 μm.
D: amount of abrasion is 30 μm or more.

### Evaluation of Contamination Resistance of Charging Member

In the evaluation test, in an environment of 28° C. and 85% RH, 100,000 sheets of a band-shaped image quality pattern having an output direction length of 320 mm and a width of 30 mm with an image intensity of 100% are printed on A3 recording paper, and then 100,000 sheets are formed in the same manner in an environment of a temperature of 10° C. and a relative humidity of 15%. The cleaning properties of the attachment are evaluated by observing the surface state of the charging roll 14 at the image quality pattern printing position. In the observation of the charging roll, the surface is directly observed using a confocal laser microscope (OLS1100, manufactured by Olympus Corporation), and the contamination resistance of the charging member is evaluated based on the following standards.

### Evaluation Standard

S: Attachments are observed on the surface of the charging roll in a range of 10% or less per 1 m².
A: Attachments are observed on the surface of the charging roll in a range of more than 10% and 20% or less per 1 m².
B: Attachments are observed on the surface of the charging roll in a range of more than 20% and 30% or less per 1 m².
C: Attachments are observed on the surface of the charging roll in a range of more than 30% and 50% or less per 1 m².
D: Attachments are observed on the surface of the charging roll in a range of more than 50% per 1 μm².

### Examples 2 to 29 and Comparative Examples 1 to 6

Electrophotographic photoreceptors, charging rolls, and cleaning rolls are prepared in the same manner as in Example 1, except that the composition of the charge transport layer, the shape of the cleaning member, and the surface roughness Rz of the charging member are changed as shown in Table 1.

In addition, the evaluation is performed in the same manner as in Example 1. The evaluation results are collectively shown in Table 1.

TABLE 1

| | Electrophotographic photoreceptor | | | | | | | |
|---|---|---|---|---|---|---|---|---|
| | | | | | Resin | | Cleaning member | |
| | | Dicarboxylic | Diol | | mass | | Thickness | Width |
| | Polyarylate | acid unit | unit | Polycarbonate | ratio | | T | W |
| | resin | mol % | mol % | resin | PAR:PC | CTM | mm | mm |
| Example 1 | 1-1 | A2-3:50 | B1-2:50 | PC1 | 7:3 | CTM-1 | 2.5 | 3.0 |
| Example 2 | 1-1 | A2-3:50 | B1-2:50 | PC1 | 7:3 | CTM-1 | 2.5 | 3.0 |
| Example 3 | 1-1 | A2-3:50 | B1-2:50 | PC1 | 7:3 | CTM-1 | 2.5 | 3.0 |
| Example 4 | 1-1 | A2-3:50 | B1-2:50 | PC1 | 7:3 | CTM-1 | 1.8 | 3.0 |
| Example 5 | 1-1 | A2-3:50 | B1-2:50 | PC1 | 7:3 | CTM-1 | 3.6 | 3.0 |
| Comparative | 1-1 | A2-3:50 | B1-2:50 | PC1 | 7:3 | CTM-1 | 1.6 | 3.0 |
| Example 1 | | | | | | | | |
| Comparative | 1-1 | A2-3:50 | B1-2:50 | PC1 | 7:3 | CTM-1 | 3.8 | 3.0 |
| Example 2 | | | | | | | | |
| Example 6 | 1-1 | A2-3:50 | B1-2:50 | PC1 | 7:3 | CTM-1 | 2.5 | 3.3 |
| Example 7 | 1-1 | A2-3:50 | B1-2:50 | PC1 | 7:3 | CTM-1 | 2.5 | 3.3 |
| Example 8 | 1-1 | A2-3:50 | B1-2:50 | PC1 | 7:3 | CTM-1 | 2.5 | 4.0 |
| Example 9 | 1-1 | A2-3:50 | B1-2:50 | PC1 | 7:3 | CTM-1 | 2.5 | 4.0 |
| Comparative | 1-1 | A2-3:50 | B1-2:50 | PC1 | 7:3 | CTM-1 | 2.5 | 5.0 |
| Example 3 | | | | | | | | |
| Comparative | 1-1 | A2-3:50 | B1-2:50 | PC1 | 7:3 | CTM-1 | 2.0 | 5.0 |
| Example 4 | | | | | | | | |
| Comparative | 1-1 | A2-3:50 | B1-2:50 | PC1 | 7:3 | CTM-1 | 2.5 | 5.0 |
| Example 5 | | | | | | | | |
| Example 10 | 1-1 | A2-3:50 | B1-2:50 | PC1 | 7:3 | CTM-1 | 3.0 | 5.0 |
| Example 11 | 1-1 | A2-3:50 | B1-2:50 | PC1 | 7:3 | CTM-1 | 2.5 | 2.5 |
| Example 12 | 1-1 | A2-3:50 | B1-2:50 | PC1 | 7:3 | CTM-1 | 2.5 | 3.0 |
| Example 13 | 1-1 | A2-3:50 | B1-2:50 | PC1 | 7:3 | CTM-1 | 2.5 | 3.0 |
| Example 14 | 1-1 | A2-3:50 | B1-2:50 | PC1 | 7:3 | CTM-1 | 2.5 | 3.0 |
| Example 15 | 1-1 | A2-3:50 | B1-2:50 | PC1 | 7:3 | CTM-1 | 2.5 | 3.0 |
| Example 16 | 1-1 | A2-3:50 | B1-2:50 | PC1 | 7:3 | CTM-1 | 2.5 | 3.0 |
| Example 17 | 1-1 | A2-3:50 | B1-2:50 | PC1 | 5:5 | CTM-1 | 2.5 | 3.0 |
| Example 18 | 1-1 | A2-3:50 | B1-2:50 | PC1 | 3:7 | CTM-1 | 2.5 | 3.0 |
| Example 19 | 1-1 | A2-3:50 | B1-2:50 | PC1 | 2:8 | CTM-1 | 2.5 | 3.0 |
| Example 20 | 1-1 | A2-3:50 | B1-2:50 | PC1 | 8:2 | CTM-1 | 2.5 | 3.0 |
| Example 21 | 1-1 | A2-3:50 | B1-2:50 | PC1 | 10:0 | CTM-1 | 2.5 | 3.0 |
| Comparative | None | | | PC1 | 0:10 | CTM-1 | 2.5 | 3.0 |
| Example 6 | | | | | | | | |
| Example 22 | 1-2 | A2-3:50 | B1-4:50 | PC1 | 7:3 | CTM-1 | 2.5 | 3.0 |
| Example 23 | 1-3 | A2-3:50 | B2-6:50 | PC1 | 7:3 | CTM-1 | 2.5 | 3.0 |
| Example 24 | 1-4 | A2-3:50 | B5-1:50 | PC1 | 7:3 | CTM-1 | 2.5 | 3.0 |
| Example 25 | 1-5 | A3-2:50 | B1-2:50 | PC1 | 7:3 | CTM-1 | 2.5 | 3.0 |
| Example 26 | 1-6 | A3-2:40 | B6-4:50 | PC1 | 7:4 | CTM-1 | 2.5 | 3.0 |
| | | A4-3:10 | | | | | | |
| Example 27 | 1-1 | A2-3:50 | B1-2:50 | PC1 | 10:0 | CTM- | 2.5 | 3.0 |
| | | | | | | 1(70%) | | |
| | | | | | | CTM- | | |
| | | | | | | 2(30%) | | |
| Example 28 | 1-1 | A2-3:50 | B1-2:50 | PC1 | 6:4 | CTM- | 2.5 | 3.0 |
| | | | | | | 1(70%) | | |
| | | | | | | CTM- | | |
| | | | | | | 2(30%) | | |
| Example 29 | 1-1 | A2-3:50 | B1-2:50 | PC3 | 3:7 | CTM-1 | 2.5 | 3.0 |

| | | | | Charging | | | |
|---|---|---|---|---|---|---|---|
| | Cleaning member | | | member | | | Contamination |
| | | Number | Coverage | Surface | | Abrasion | resistance |
| | Ratio | of | area | roughness | | resistance of | of charging |
| | T/W | rolls | ratio A | Rz | | photoreceptor | member |
| Example 1 | 0.83 | 3 | 63% | 6 | μm | A | S |
| Example 2 | 0.83 | 2 | 42% | 6 | μm | A | A |
| Example 3 | 0.83 | 1 | 21% | 6 | μm | A | A |
| Example 4 | 0.60 | 1 | 21% | 6 | μm | A | B |
| Example 5 | 1.20 | 1 | 21% | 6 | μm | A | B |
| Comparative | 0.53 | 1 | 21% | 6 | μm | B | D |
| Example 1 | | | | | | | |
| Comparative | 1.27 | 1 | 21% | 6 | μm | B | D |
| Example 2 | | | | | | | |
| Example 6 | 0.76 | 3 | 70% | 6 | μm | A | A |
| Example 7 | 0.76 | 1 | 46% | 6 | μm | A | A |
| Example 8 | 0.63 | 2 | 56% | 6 | μm | A | C |
| Example 9 | 0.63 | 1 | 28% | 6 | μm | A | C |
| Comparative | 0.50 | 1 | 35% | 6 | μm | A | D |
| Example 3 | | | | | | | |
| Comparative | 0.40 | 1 | 35% | 6 | μm | A | D |
| Example 4 | | | | | | | |
| Comparative | 0.50 | 1 | 35% | 6 | μm | A | D |
| Example 5 | | | | | | | |
| Example 10 | 0.60 | 1 | 35% | 6 | μm | A | C |
| Example 11 | 1.00 | 1 | 18% | 6 | μm | A | C |
| Example 12 | 0.83 | 1 | 21% | 5 | μm | A | A |
| Example 13 | 0.83 | 1 | 21% | 8 | μm | A | A |
| Example 14 | 0.83 | 1 | 21% | 10 | μm | A | A |
| Example 15 | 0.83 | 1 | 21% | 4 | μm | A | B |
| Example 16 | 0.83 | 1 | 21% | 11 | μm | A | B |
| Example 17 | 0.83 | 1 | 21% | 6 | μm | A | A |
| Example 18 | 0.83 | 1 | 42% | 6 | μm | A | A |
| Example 19 | 0.83 | 1 | 42% | 6 | μm | B | A |
| Example 20 | 0.83 | 1 | 42% | 6 | μm | S | B |
| Example 21 | 0.83 | 1 | 42% | 6 | μm | S | B |
| Comparative | 0.83 | 1 | 42% | 6 | μm | D | B |
| Example 6 | | | | | | | |
| Example 22 | 0.83 | 1 | 21% | 6 | μm | A | A |
| Example 23 | 0.83 | 1 | 21% | 6 | μm | A | A |
| Example 24 | 0.83 | 1 | 21% | 6 | μm | B | A |
| Example 25 | 0.83 | 1 | 21% | 6 | μm | C | A |
| Example 26 | 0.83 | 1 | 21% | 6 | μm | C | A |
| Example 27 | 0.83 | 1 | 42% | 6 | μm | S | B |
| Example 28 | 0.83 | 1 | 21% | 6 | μm | A | A |
| Example 29 | 0.83 | 1 | 42% | 6 | μm | B | A |

The resin mass ratio PAR:PC in Table 1 is a ratio of the polyarylate resin to the polycarbonate resin. In addition, the polycarbonate resin used in Example 29 is a polycarbonate resin PC-3 having the following structure.

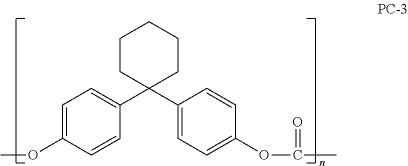

In CTM used in Examples 27 and 28, CTM-1 and CTM-2 are used in combination at a mass ratio of 30:70.

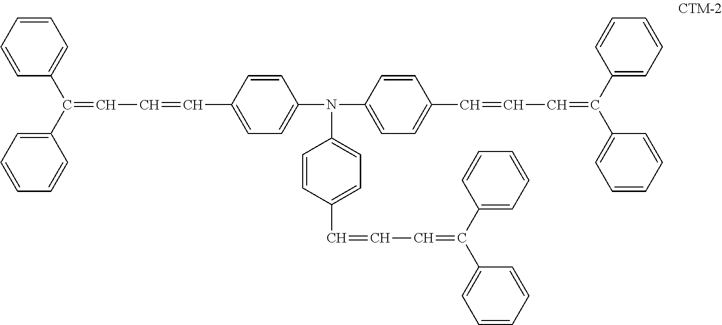 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

### Examples 30 to 34 and Comparative Examples 7 and 8

Further, for Examples 30 to 34 and Comparative Examples 7 and 8 shown in Table 2, cleaning rolls are produced in the same manner as in Example 1 except that the shape of the cleaning member is changed, and each member is modified and mounted on a drum cartridge of an image forming apparatus “bizhub C287 manufactured by Konica Minolta, Inc.”, and abrasion resistance of a photoreceptor and contamination resistance of a charging member are evaluated in the same manner as in Example 1.

The evaluation results are collectively shown in Table 2.

TABLE 2

| | Electrophotographic photoreceptor | | | | | | | |
|---|---|---|---|---|---|---|---|---|
| | | | | | Resin | | Cleaning member | |
| | | Dicarboxylic | Diol | | mass | | Thickness | Width |
| | Polyarylate | acid unit | unit | Polycarbonate | ratio | | T | W |
| | resin | mol % | mol % | resin | PAR:PC | CTM | mm | mm |
| Example 30 | 1-1 | A2-3:50 | B1-2:50 | PC-1 | 7:3 | CTM-1 | 2.5 | 3.0 |
| Example 31 | 1-1 | A2-3:50 | B1-2:50 | PC-1 | 7:3 | CTM-1 | 2.5 | 3.0 |
| Example 32 | 1-1 | A2-3:50 | B1-2:50 | PC-1 | 7:3 | CTM-1 | 2.5 | 3.0 |
| Example 33 | 1-1 | A2-3:50 | B1-2:50 | PC-1 | 7:3 | CTM-1 | 1.8 | 3.0 |
| Example 34 | 1-1 | A2-3:50 | B1-2:50 | PC-1 | 7:3 | CTM-1 | 3.6 | 3.0 |
| Comparative | 1-1 | A2-3:50 | B1-2:50 | PC-1 | 7:3 | CTM-1 | 1.6 | 3.0 |
| Example 7 | | | | | | | | |
| Comparative | 1-1 | A2-3:50 | B1-2:50 | PC-1 | 7:3 | CTM-1 | 3.8 | 3.0 |
| Example 8 | | | | | | | | |

| | | | | Charging | | Contamination- |
|---|---|---|---|---|---|---|
| | Cleaning member | | | member | Abrasion- | suppressing |
| | | Number | Coverage | Surface | suppressing | properties of |
| | Ratio | of | area | roughness | properties of | charging |
| | T/W | rolls | ratio A | Rz | photoreceptor | member |
| Example 30 | 0.83 | 3 | 63% | 6 μm | A | A |
| Example 31 | 0.83 | 2 | 42% | 6 μm | A | A |
| Example 32 | 0.83 | 1 | 21% | 6 μm | A | B |
| Example 33 | 0.60 | 1 | 21% | 6 μm | A | C |
| Example 34 | 1.20 | 1 | 21% | 6 μm | A | C |
| Comparative | 0.53 | 1 | 21% | 6 μm | B | D |
| Example 7 | | | | | | |
| Comparative | 1.27 | 1 | 21% | 6 μm | B | D |
| Example 8 | | | | | | |

As shown in Tables 1 and 2, the image forming apparatuses of Examples 1 to 34 are excellent in abrasion-suppressing properties of the photoreceptor and contamination-suppressing properties of the charging member, as compared with the image forming apparatuses of Comparative Examples 1 to 8.

(((1))) An image forming apparatus comprising:
an electrophotographic photoreceptor; and
a charging device including a charging member that charges a surface of the electrophotographic photoreceptor and a cleaning member that is disposed in contact with the charging member,
wherein the electrophotographic photoreceptor has a conductive substrate and a photosensitive layer disposed on the conductive substrate, and an outermost surface layer of the electrophotographic photoreceptor contains a charge transport material and a polyarylate resin having a dicarboxylic acid unit represented by Formula (A) and a diol unit represented by Formula (B),
the cleaning member has a core metal and a foamed elastic layer provided in a helical shape on an outer peripheral surface of the core metal, and
a value of a ratio T/W of a thickness T of the foamed elastic layer to a width W of the foamed elastic layer is 0.6 or more and 1.2 or less.

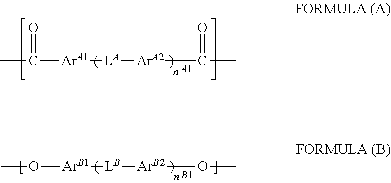

In Formula (A), Ar^{A1} and Ar^{A2} are each independently an aromatic ring which may have a substituent, L^{A} is a single bond or a divalent linking group, and n^{A1} is 0, 1, or 2.

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2. Where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

(((2))) The image forming apparatus according to (((1))),
wherein a coverage area ratio A of the foamed elastic layer provided in the cleaning member is 20% by area or more and 60% by area or less.

(((3))) The image forming apparatus according to (((1))) or (((2))),
wherein a surface roughness Rz of the charging member is 5 μm or more and 10 μm or less.

(((4))) The image forming apparatus according to any one of (((1))) to (((3))),
wherein the outermost surface layer of the electrophotographic photoreceptor further contains a polycarbonate resin.

(((5))) The image forming apparatus according to (((4))),
wherein a mass ratio of the polyarylate resin to the polycarbonate resin in the outermost surface layer of the electrophotographic photoreceptor is 3:7 to 7:3.

(((6))) The image forming apparatus according to any one of (((1))) to (((5))),
wherein the dicarboxylic acid unit represented by Formula (A) includes at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), a dicarboxylic acid unit (A4) represented Formula (A4), and a dicarboxylic acid unit (A5) represented by Formula (A5).

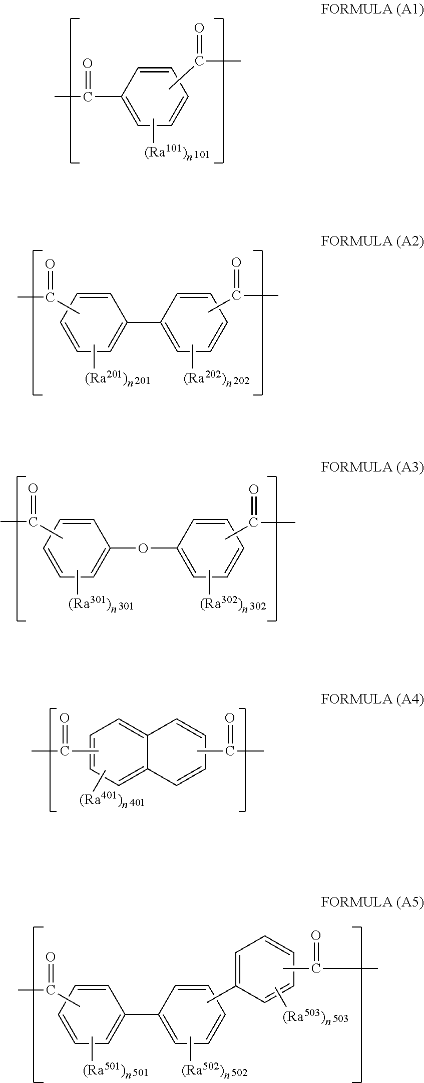

In Formula (A1), n¹⁰¹ is an integer of 0 or greater and 4 or less, and n¹⁰¹ pieces of Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms.

In Formula (A2), n²⁰¹ and n²⁰² are each independently an integer of 0 or greater and 4 or less, and n²⁰¹ pieces of Ra²⁰¹'s and n²⁰² pieces of Ra²⁰²'s are each independently an alkyl group having 1 or more and 10 or less carbon atoms, an aryl group having 6 or more and 12 or less carbon atoms, or an alkoxy group having 1 or more and 6 or less carbon atoms.

In Formula (A3), n³⁰¹ and n³⁰² are each independently an integer of 0 or greater and 4 or less, and n³⁰¹ pieces of Ra³⁰¹'s and n³⁰² pieces of Ra³⁰²'s are each independently an alkyl group having 1 or more and 10 or less carbon atoms, an aryl group having 6 or more and 12 or less carbon atoms, or an alkoxy group having 1 or more and 6 or less carbon atoms.

In Formula (A4), n⁴⁰¹ is an integer of 0 or greater and 6 or less, and n⁴⁰¹ pieces of Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms.

In Formula (A5), n⁵⁰¹, n⁵⁰², and n⁵⁰³ are each independently an integer of 0 or greater and 4 or less, and n⁵⁰¹ pieces of Ra⁵⁰¹'s, n⁵⁰² pieces of Ra⁵⁰²'s, and n⁵⁰³ pieces of Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.

(((7))) The image forming apparatus according to any one of (((1))) to (((6))),
wherein the diol unit represented by Formula (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

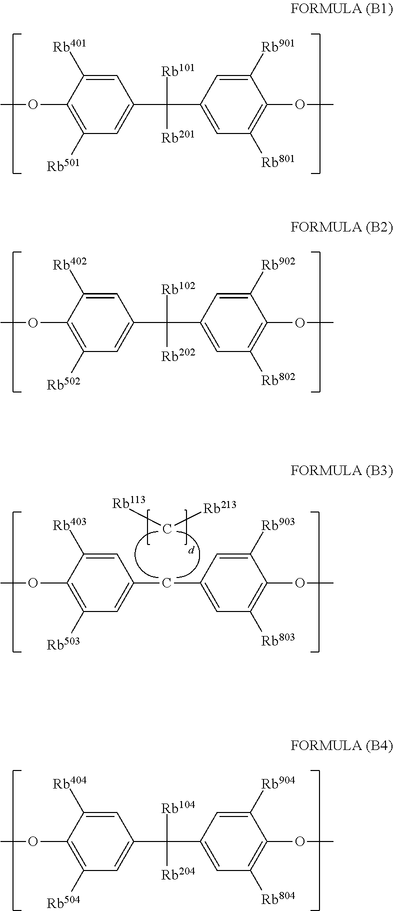

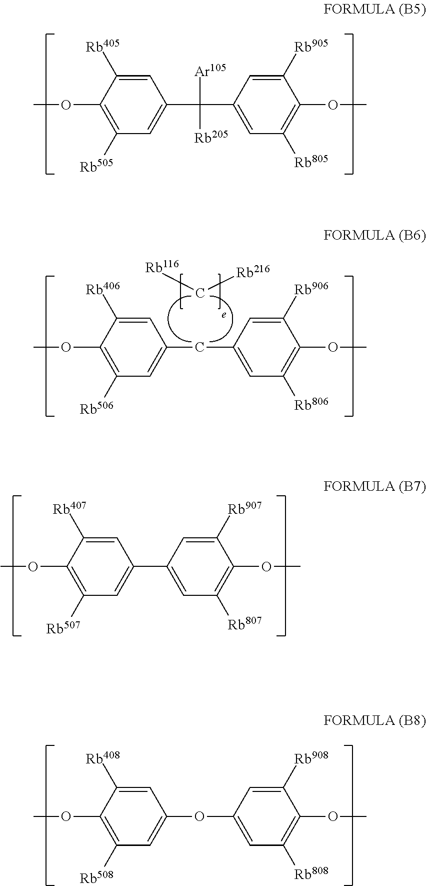

In Formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom.

In Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom.

In Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or greater and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom.

In Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom.

In Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom.

In Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or greater and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom.

In Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom.

In Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

(((8))) The image forming apparatus according to (((4))),
wherein the polyarylate resin and the polycarbonate resin each have a constitutional unit including biphenyl represented by Formula (BP).

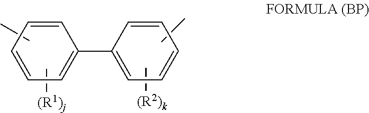

In Formula (BP), j is an integer of 0 or greater and 4 or less, j pieces of R's are each independently a methyl group or an ethyl group, k is an integer of 0 or greater and 4 or less, and k pieces of R²'s are each independently a methyl group or an ethyl group.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an electrophotographic photoreceptor; and
a charging device including a charging member that charges a surface of the electrophotographic photoreceptor and a cleaning member that is disposed in contact with the charging member,
wherein the electrophotographic photoreceptor has a conductive substrate and a photosensitive layer disposed on the conductive substrate, and an outermost surface layer of the electrophotographic photoreceptor contains a charge transport material and a polyarylate resin having a dicarboxylic acid unit represented by Formula (A) and a diol unit represented by Formula (B),
the cleaning member has a core metal and a foamed elastic layer provided in a helical shape on an outer peripheral surface of the core metal, and
a value of a ratio T/W of a thickness T of the foamed elastic layer to a width W of the foamed elastic layer is 0.6 or more and 1.2 or less, 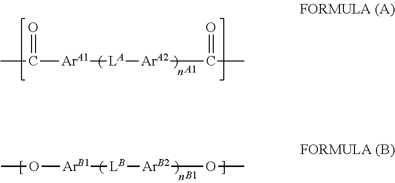
in Formula (A), Ar^{A1} and Ar^{A2} are each independently an aromatic ring which may have a substituent, L^{A} is a single bond or a divalent linking group, and n^{A1} is 0, 1, or 2,
in Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

2. The image forming apparatus according to claim 1,
wherein a coverage area ratio A of the foamed elastic layer provided in the cleaning member is 20% by area or more and 60% by area or less.

3. The image forming apparatus according to claim 1,
wherein a surface roughness Rz of the charging member is 5 μm or more and 10 μm or less.

4. The image forming apparatus according to claim 1,
wherein the outermost surface layer of the electrophotographic photoreceptor further contains a polycarbonate resin.

5. The image forming apparatus according to claim 4,
wherein a mass ratio of the polyarylate resin to the polycarbonate resin in the outermost surface layer of the electrophotographic photoreceptor is 3:7 to 7:3.

6. The image forming apparatus according to claim 1,
wherein the dicarboxylic acid unit represented by Formula (A) includes at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), a dicarboxylic acid unit (A4) represented Formula (A4), and a dicarboxylic acid unit (A5) represented by Formula (A5), 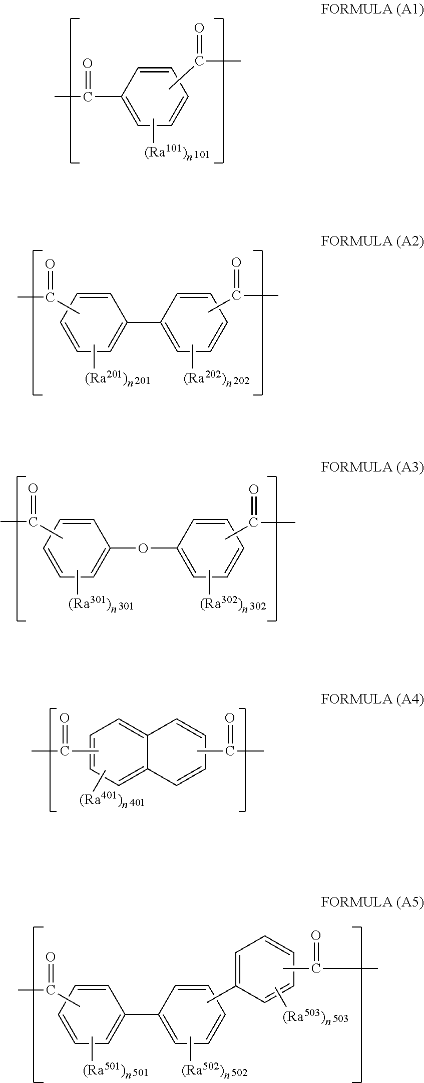
in Formula (A1), n¹⁰¹ is an integer of 0 or greater and 4 or less, and n¹⁰¹ pieces of Ra¹⁰¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (A2), n²⁰¹ and n²⁰² are each independently an integer of 0 or greater and 4 or less, and n²⁰¹ pieces of Ra²⁰¹'s and n²⁰² pieces of Ra²⁰²'s are each independently an alkyl group having 1 or more and 10 or less carbon atoms, an aryl group having 6 or more and 12 or less carbon atoms, or an alkoxy group having 1 or more and 6 or less carbon atoms,
in Formula (A3), n³⁰¹ and n³⁰² are each independently an integer of 0 or greater and 4 or less, and n³⁰¹ nieces of Ra³⁰¹'s and n³⁰² nieces of Ra³⁰²'s are each independently an alkyl group having 1 or more and 10 or less carbon atoms, an aryl group having 6 or more and 12 or less carbon atoms, or an alkoxy group having 1 or more and 6 or less carbon atoms,
in Formula (A4), n⁴⁰¹ is an integer of 0 or greater and 6 or less, and n⁴⁰¹ pieces of Ra⁴⁰¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (A5), n⁵⁰¹, n⁵⁰², and n⁵⁰³ are each independently an integer of 0 or greater and 4 or less, and n⁵⁰¹ pieces of Ra⁵⁰¹'s, n⁵⁰² pieces of Ra⁵⁰²'s, and n⁵⁰³ pieces of Ra⁵⁰³'s are each independently an alkyl group having 1 or more and 10 or less carbon atoms, an aryl group having 6 or more and 12 or less carbon atoms, or an alkoxy group having 1 or more and 6 or less carbon atoms.

7. The image forming apparatus according to claim 1,
wherein the diol unit represented by Formula (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8), 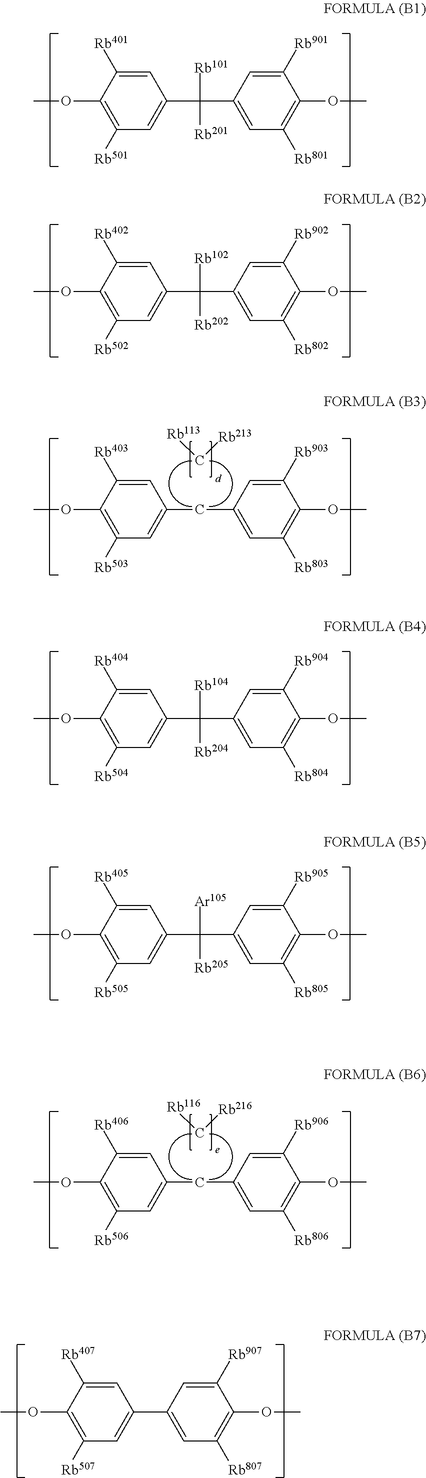 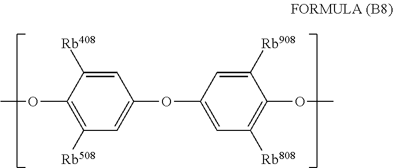
in Formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom,
in Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom,
in Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or greater and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom,
in Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom,
in Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom,
in Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or greater and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom,
in Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom,
in Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

8. The image forming apparatus according to claim 1,
wherein the polyarylate resin and the polycarbonate resin each have a constitutional unit including biphenyl represented by Formula (BP), 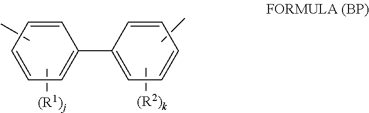
in Formula (BP), j is an integer of 0 or greater and 4 or less, j pieces of R¹'s are each independently a methyl group or an ethyl group, k is an integer of 0 or greater and 4 or less, and k pieces of R²'s are each independently a methyl group or an ethyl group.
